(19) United States
(12) Patent Application Publication
(10) Pub. No.: US 2004/0054546 A1
(43) Pub. Date: Mar. 18, 2004

(54) Method and apparatus for selecting a jury

(75) Inventors: Martin Levin, Pensacola, FL (US); Fred Levin, Gulf Breeze, FL (US); Shane Lincke, Pace, FL (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SmartCOP, Inc.

(21) Appl. No.: 10/263,821

(22) Filed: Oct. 4, 2002

Related U.S. Application Data
(60) Provisional application No. 60/410,005, filed on Sep. 12, 2002.

(51) Int. Cl. G06F 7/00

(52) U.S. Cl. 705/1

(57) ABSTRACT

A system includes a memory device and a processor. The processor communicates with the memory device. The processor is configured to record courtroom event information, in real time, based upon events occurring within a courtroom during a jury selection process. The processor is also configured to select member of the jury from a jury panel based upon events occurring within the courtroom during a jury selection process.

### REFERENCE TO RELATED APPLICATIONS

This application claims priority of U.S. Provisional Patent Application Serial No. 60/410,005, filed on Sep. 12, 2002. The contents of the provisional application are hereby incorporated by reference.

### BACKGROUND OF THE INVENTION

1. Field of the Invention

This invention relates to a system and method for automatically and objectively selecting members of a jury. The invention is also directed to computer programs and methods for dynamically monitoring and recording courtroom events and potential jurors' behavior and responses and for dynamically selecting members of a jury.

2. Description of the Related Art

The jury selection process is one of the most critical aspects of a trial, because the jurors will ultimately decide a defendant's guilt or innocence. However, during a jury selection process, there are numerous tasks that each party must perform and monitor simultaneously in order to select the members of the jury. During the voir dire process, each party wishes to devise a strategy that will allow them to assemble a jury panel that is most favorable to their parties' interest. Each party must conduct an examination of each potential juror, assess each juror's ability to be objective to their party and challenge any juror whom cannot render an unbiased opinion to their party. Once the judge or presiding authority initiates the jury selection process, each party is required to perform these tasks while gathering a large amount of data within a short amount of time at a very fast pace.

Accordingly, new and improved systems and methods for monitoring and recording courtroom events in order to assist each party in selecting the members of the jury are needed.

### SUMMARY OF THE INVENTION

According to an embodiment of the invention, provided is a system including a memory device and a processor. The processor communicates with the memory device. The processor is configured to record courtroom event information, in real time, based upon events occurring within a courtroom during a jury selection process. The processor is also configured to select members of the jury from a jury panel based upon events occurring within the courtroom during a jury selection process.

According to another embodiment of the invention, provided is a system. The system includes a memory device and a processor. The processor is in communication with the memory device. The processor is configured to receive pre-jury selection preparation information and to record courtroom event information, in real time, based upon events occurring within a courtroom during a jury selection process. The processor is also configured to select members of the jury from a juror panel based upon the courtroom event information and the pre-jury selection preparation information.

According to another embodiment of the invention, provided is a system for recording courtroom event information. The system includes a memory device and a processor that is in communication with the memory device. The processor is configured to record, in real time, statements made during a jury selection process, wherein the statements support at least one legal challenge asserted by at least one participant of the jury selection process. The processor is further configured to utilize a jury selection management system to select members of a jury based upon the statements made during the jury selection process and the legal challenges asserted during the jury selection process.

Provided in an alternate embodiment is a system for creating a seating chart of members of a juror panel. The system includes a memory device and a processor that is in communication with the memory device. The processor is configured to record seating positions assigned to potential jurors, in real time, during a jury selection process. The processor is further configured to create a seating chart based upon the seating positions, in real time; and provide selectable representations, in real time, based upon the seating chart, wherein the selectable representations represents the potential jurors on a display screen of the processor.

In another embodiment, provided is a system for recording courtroom event information. The system includes a memory device and a processor in communication with the memory device. The processor is configured to record at least one body language action exhibited by a potential juror during a jury selection process and utilize a jury selection management system to select members of a jury based upon the at least one body language action exhibited by the potential juror during the jury selection process.

### BRIEF DESCRIPTION OF THE DRAWINGS

The objects and features of the invention will be more readily understood with reference to the following description and the attached drawings, wherein:

FIG. 1A is a block diagram of a system according to an embodiment of the invention;

FIG. 1B is a flowchart of a pre-selection preparation method according to an embodiment of the invention;

FIG. 1C is a flowchart of a jury selection process according to an embodiment of the invention;

FIG. 2 is a block diagram of a main interface according to an embodiment of the invention;

FIG. 3A is a block diagram of a create new case interface according to an embodiment of the invention;

FIG. 3B is a block diagram of a case configuration interface according to an embodiment of the invention;

FIG. 4 is a block diagram of a case scores interface according to an embodiment of the invention;

FIGS. 5A-5B are block diagram of a case question interface according to an embodiment of the invention;

FIG. 6 illustrates a block diagram of a potential jurors interface according to an embodiment of the invention;

FIG. 7 depicts a seating chart configuration interface according to an embodiment of the invention;

FIG. 8 shows a juror seat assignment interface according to an embodiment of the invention;

FIG. 9 is a block diagram of juror answer mode interface according to an embodiment of the invention;

FIGS. 10A-10B show a main case interface according to an embodiment of the invention;

FIG. 11 illustrates features that may be included in the main interface according to an embodiment of the invention;

FIG. 12 depicts a case name and case description interface according to an embodiment of the invention;

FIG. 13 shows a configure case interface according to an embodiment of the invention;

FIGS. 14A-14B represent a rating system that may be employed according to an embodiment of the invention;

FIGS. 14C-14D illustrate an age factor score interface according to an embodiment of the invention;

FIG. 14E represents a case configuration interface according to an embodiment of the invention;

FIGS. 15A-15F illustrate one or more question databases that may be employed according to an embodiment of the invention;

FIGS. 16A-16C depict a potential jurors interface according to an embodiment of the invention;

FIG. 17 illustrates a seating chart that may be generated in the seating chart configuration interface according to an embodiment of the invention;

FIGS. 18A-18B illustrate the assignment of the seating position in the assign seats interface according to an embodiment of the invention;

FIG. 19A shows a question/response interface according to an embodiment of the invention;

FIGS. 19B-19C show a ratings addition interface according to an embodiment of the invention;

FIG. 20 depicts a print interface according to an embodiment of the invention;

FIG. 21 illustrates an example of the type of information that may be displayed visually on a display screen according to an embodiment of the invention;

FIG. 22 shows a cause alert interface according to an embodiment of the invention;

FIG. 23A illustrates a body language interface according to an embodiment of the invention;

FIG. 23B illustrates the type of information that can be displayed in the juror representation on screen;

FIG. 24 depicts an add rating interface according to an embodiment of the invention; and

FIG. 25 depicts a juror seating chart according to an embodiment of the invention.

### DETAILED DESCRIPTION OF THE PREFERRED EMBODIMENTS

The invention relates to, according to one embodiment, a method and apparatus for objectively and dynamically selecting members from a group utilizing a real-time selection process management system. For instance, the invention may be employed as a jury selection management system 200 to dynamically select jurors from a potential juror pool.

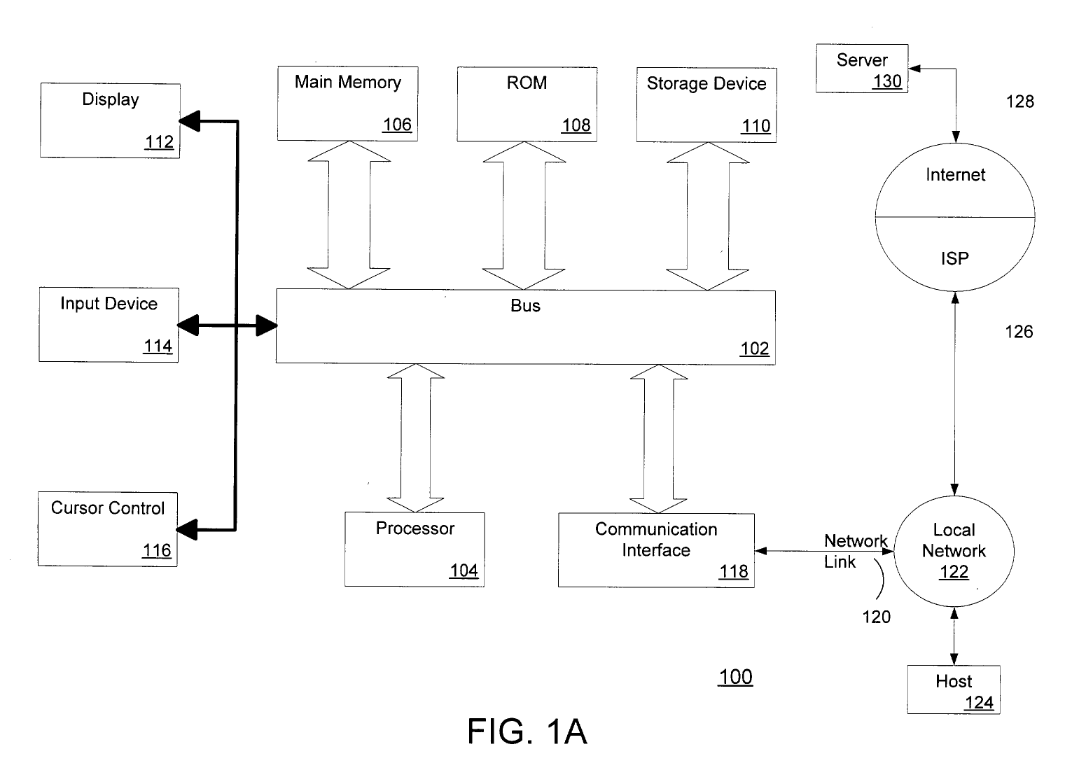

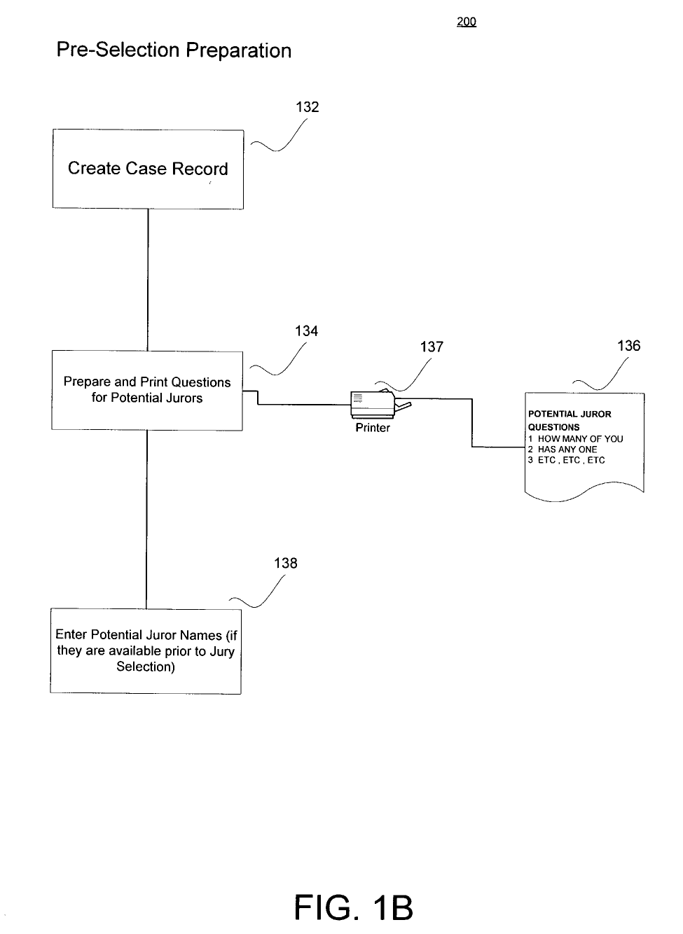

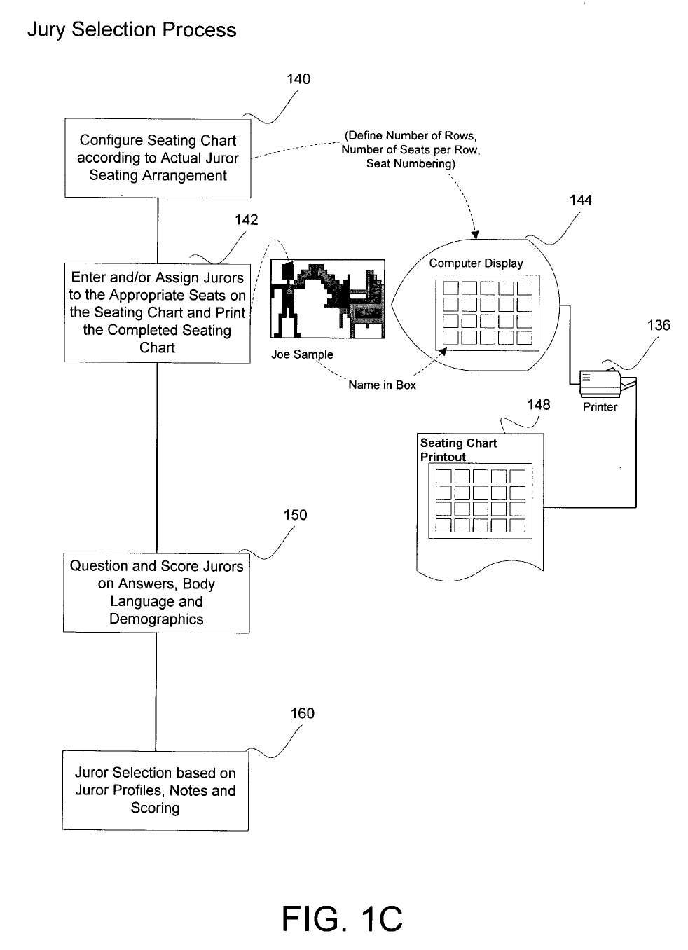

FIG. 1A is a block diagram that illustrates a computer system 100 upon which an embodiment of the invention may be implemented. Computer system 100 may include a bus 102 or other communication mechanism for communicating information, and a processor 104 coupled with bus 102 for processing information. Computer system 100 may also include a main memory 106, such as a random access memory (RAM) or other dynamic storage device, coupled to bus 102 for storing information and instructions to be executed by processor 104. Main memory 106 also may be used for storing temporary variable or other intermediate information during execution of instructions to be executed by processor 104. Computer system 100 may further include a read only memory (ROM) 108 or other static storage device coupled to bus 102 for storing information and instructions for processor 104. A storage device 110, such as a magnetic disk or optical disk, may be provided and coupled to bus 102 for storing information and instructions.

Computer system 100 may be coupled via bus 102 to a display 112, such as a cathode ray tube (CRT) or flat panel display, for displaying information to a computer user. An input device 114, including alphanumeric and other keys, voice-activated and/or touch-sensitive screens, may be coupled to bus 102 for communicating information and command selections to processor 104. Another type of user input device may be a cursor control 116, such as a mouse, a trackball, or cursor direction keys for communicating direction information and command selections to processor 104 and for controlling cursor movement on display 112.

According to one embodiment of the invention, the jury selection management system may be provided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 may cause processor 104 to perform the process steps described herein. One or more processors in a multiprocessing arrangement may also be employed to execute the sequences of instructions contained in place of or in combination with software instructions to implement the invention. Thus, embodiments of the invention are not limited to any specific combination of hardware circuitry and software.

The term “computer-readable medium” as used herein may refer to any medium that participates in providing instructions to processor 104 for execution. Such a medium may take many forms, including, but not limited to, non-volatile media, volatile media, and transmission media. Non-volatile media may include, for example, optical or magnetic disks, such as storage device 110. Volatile media may include dynamic memory, such as main memory 106. Transmission media may include coaxial cables, copper wire, and fiber optics, including the wires that comprise bus 102. Transmission media can also take the form of acoustic or light waves, such as those generated during radio frequency (RF) and infrared (IR) data communications. Common forms of computer-readable media may include, for example, floppy disk, a flexible disk, hard disk, magnetic tape, any other magnetic medium, a CD-ROM, DVD, any other optical medium, punch cards, paper tape, any other physical medium with patterns of holes, a RAM, a Programmable read-only memory (PROM), an erasable programmable read-only memory (EPROM), a FLASH-EPROM, any other memory chip or cartridge, a carrier wave as described hereinafter, or any other medium which a computer can read.

Computer system 100 may also include a communication interface 118 coupled to bus 102. Communication interface 118 may provide a two-way data communication coupling to a network link 120 that may be connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented in the invention. In any such implementation, communication interface 118 may send and receive electrical, electromagnetic, or optical signals that carry digital data streams representing various type of information.

Network link 120 may provide data communication through one or more networks to other data devices. For example, network link 120 may provide a connection through network 122 to a host computer 124 or to data equipment operated by an Internet Service Provider (ISP) 126. ISP 126 in turn may provide data communication services through the worldwide packet data communication network, also referred to as the “Internet” 128. Local network 122 and Internet 128 may both use electrical, electromagnetic, or optical signals that carry digital data streams. The signals through the various networks and the signals on network link 120 and through communication interface 118, which carry the digital data to and from computer system 100, are exemplary forms of carrier waves transporting the information. Network link 120 may also communicate with devices such as personal digital assistants (PDAs), Tablet PCs, data enabled phones and wireless devices.

Computer system 100 can send messages and receive data, including program codes, through the network(s), network link 120, and communication interface 118. In the Internet example, a server 130 may transmit a requested code for an application program through Internet 128, ISP 126, local network 122, and/or communication interface 118.

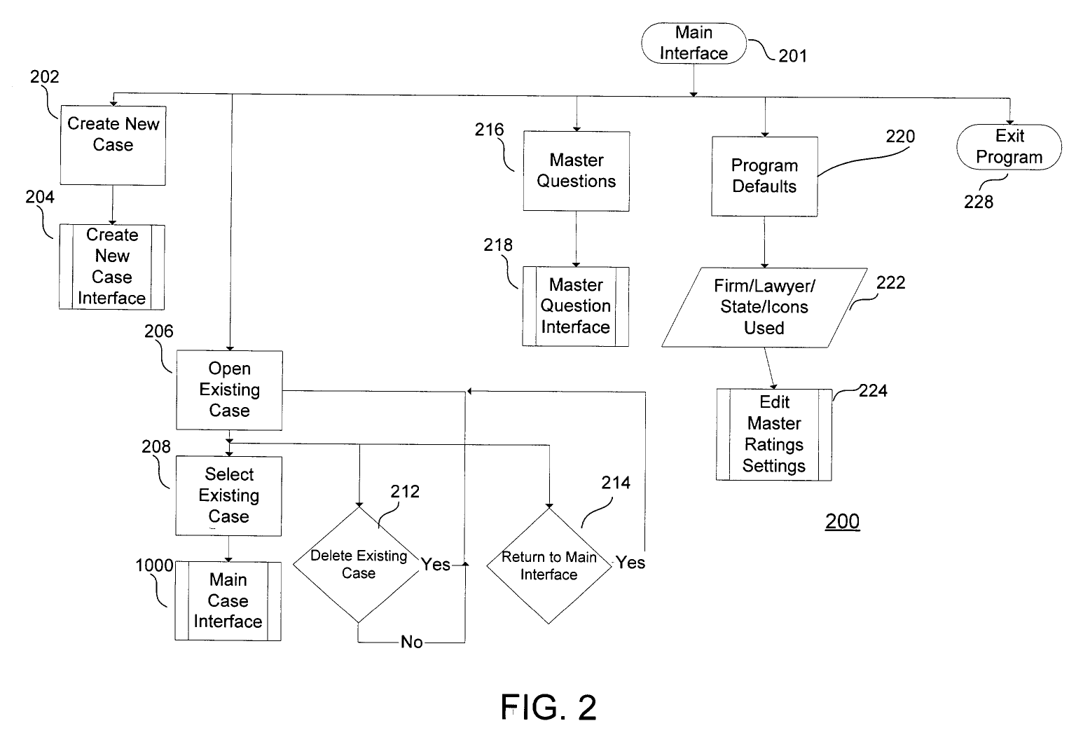

FIG. 2 is a block diagram of a structural overview of a jury selection management system 200 which may be employed according to an embodiment of the invention. Jury selection management system 200 may dynamically monitor the questions presented to members of a juror pool and record the responses provided by each member of the juror pool. Based upon the potential jurors' responses, the jury selection management system 200 may objectively and dynamically select the jury panel. In a courtroom, a judge presiding over a jury selection process may conduct the jury selection process in a fast-paced, arbitrary and capricious manner. Thus, an attorney who is conducting the “voir dire”, i.e., the jury selection process, may receive an enormous amount of information regarding each potential juror within a relatively short period of time. Nevertheless, each party must be able to assimilate and process this information and make a fairly quick decision as to the members of the juror panel whom would most likely best serve each party's interest.

For example, at the beginning of the jury selection process, the judge may invite the potential jurors into the courtroom and arbitrarily assign the seating order of the potential jurors. The judge may instruct, “On the first row, we will position ten potential jurors, on the second row, there will be eight potential jurors, on the third row, there will be eight potential jurors and on the fourth row there will be nine potential jurors.” The judge may then state, “We will begin numbering the potential jurors starting in the first row from left to right.” Typically, the judge will then instruct the attorneys to create a seating chart and numbering system according to the assigned seating arrangement. The attorneys will immediately construct a seating chart manually based upon the judge's assigned seating arrangement. Since each judge may have a different format or procedure for establishing the seating arrangement, it is oftentimes difficult for an attorney to construct a chart in advance of the jury selection process.

Although an attorney may receive, in advance from the court, a list which may name, for example, 300 potential jurors before the jury selection process begins, the attorney will not ultimately know who has been selected from the list to appear in court as a member of the juror pool until the judge begins to introduce the potential jurors. Thus, each party must be prepared to react immediately to the judge's introduction of the potential jurors. At the beginning of the introduction of the potential jurors, the judge may sometimes provide each party with a legal size piece of paper, which illustrates several small boxes that are meant to be representative of the potential jurors as seated in the venire seating. As soon as the jury selection process begins, the representatives for each party may attempt to record the events regarding each potential juror within the small boxes. However, since the juror pool may include forty or sixty potential jurors, the small boxes printed on the legal-sized paper, oftentimes, may not provide a sufficient amount of space to record each potential juror's information and to document the courtroom events. As the fast pace of the jury selection process proceeds, most of the time, the attorneys will end up with a legal-sized paper containing incomprehensible notes and shorthand notations, such as circles, arrows and scribbled text, drawn all over the chart. Each party must quickly analyze the composition of the juror pool, assesses each potential juror's background, if such information is available, and immediately formulate a strategy that would best serve each party's interest. Then, the judge may announce all of a sudden, “Let's select the jurors.” As each party may attempt to rely upon their confusing shorthand notation to select the jurors, a party may allow someone who should have been omitted or stricken to be inadvertently selected for the jury. Obviously, having to perform such tasks simultaneously can be an overwhelming and daunting task for both parties of the case; especially given the fact that the selection of the jury is the most critical aspect of a trial since the members of the jury will ultimately decide a defendant's guilt or innocence.

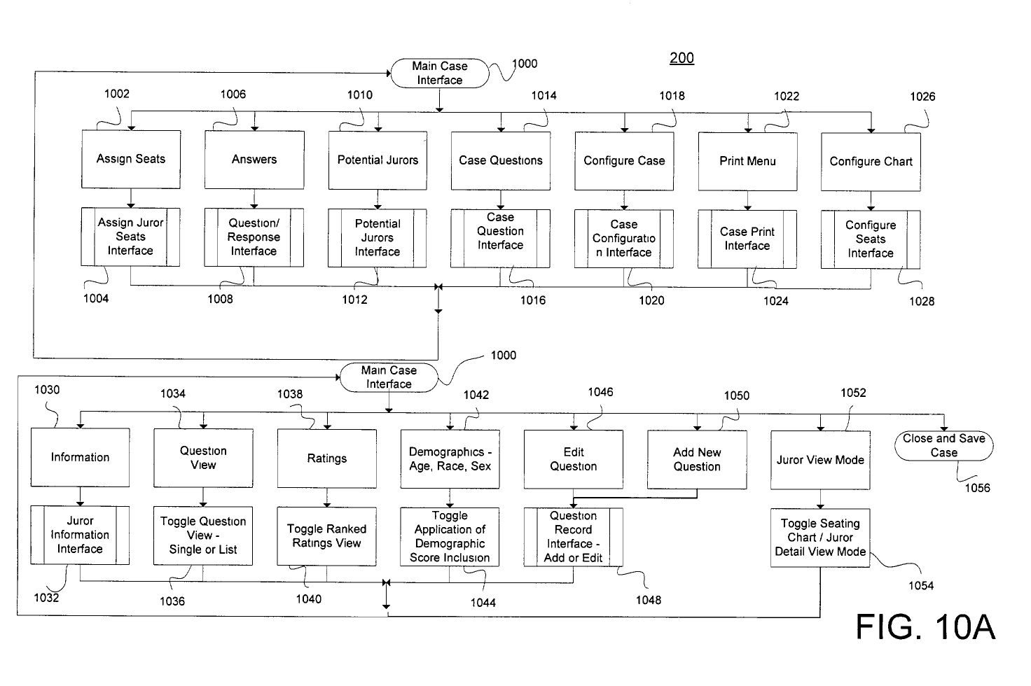

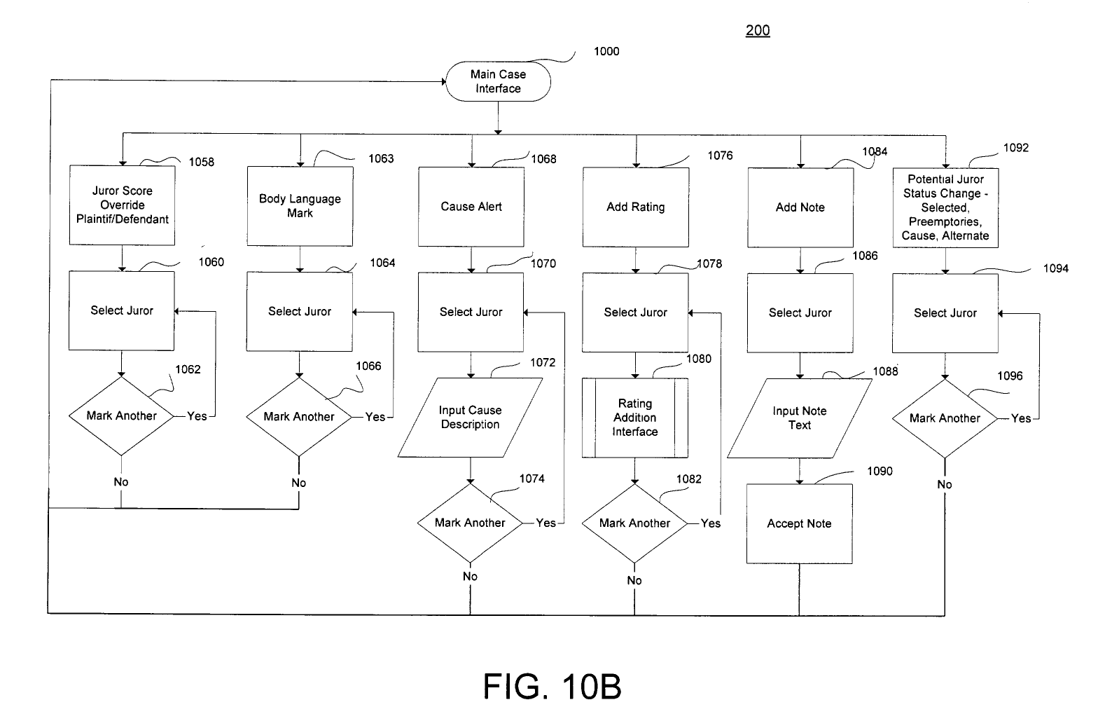

As shown in FIGS. 10A-10B, the jury selection management system 200, according to an embodiment of the invention, may enable a user to record the events electronically as they occur within the courtroom, provide a computer generated printout and record of the events, and perform a statistical analysis on the recorded events to aid in the selection of the jurors. The jury selection management system 200 can also provide computerized charts and graphs indicating the juror's score and response to each question or a grouping of questions. The jury selection management system 200 may also automatically and dynamically rate the potential jurors as the events occur within the courtroom. Thus, the jury selection management system 200 provides a concise and orderly method of monitoring, tracking and recording courtroom events.

The jury selection management system 200, according to an embodiment of the invention, may be capable of automatically constructing a seating chart as the judge directs the potential jurors to their seating assignment. In preparation for the trial, the invention may provide a simulation or a replica of a courtroom's jury box. The jury selection management system 200 may be pre-programmed by a programmer or user to include configurations of a particular courtroom's jury box or any other physical aspect of a courtroom's layout. Alternatively, the invention may be programmed to construct a standard courtroom jury box and other physical aspect of a courtroom. Prior to the initiation of the jury selection process, a user of the jury selection management system 200 may select from a list of pre-programmed courtroom jury box configurations. If the jury box configuration for a particular courtroom has not been pre-programmed into the system, the user may select the standard courtroom jury configuration interface.

Thus, as the potential jurors enter the courtroom, the user of the jury selection management system 200 may dynamically assign the users to seats. For example, the user may enter the juror's seating assignment by touching a touch-sensitive screen, activating a cursor control device 106, such as a mouse, a trackball or cursor direction keys. The user may also use alphanumeric keys to input the seating arrangement. Thus, as the judge announces each potential juror's name and seating position, the user may automatically enter the potential juror's assigned seating. Alternatively and/or conjunctively, a photographic device, such as a digital camera, may be connected to the jury selection management system so that a photograph of each user may be taken and automatically transferred into the jury selection management system 200. The photograph of each potential juror may be displayed on the display 112 within each potential juror's seating position. Thus, according to this embodiment, the invention may provide the user with a visual photograph, which may serve as a selectable representation, of the potential juror.

Entry of the assigned seat or any other courtroom event may also be entered remotely by a user of the jury selection management system 200 who is viewing the courtroom events via a remote connection, such as via a television or satellite communication. As the remote user enters the seating position, the juror's position may automatically appear on display 112 for other persons located inside and outside of the courtroom to view the courtroom events. Each party's jury management selection system 200 may be interactively connected to a court-operated device. A courtroom employee such as a judge or a clerk of the court may operate the court-operated device, and the court-operated device may capable of assigning the jurors' seating. Thus, the seating assignments interface for each party's device may interactively communicate with the court-operated device so that when the court employee uses the court-operated device to assign a juror to a seat each party's seating chart may also be automatically updated on each party's computer device.

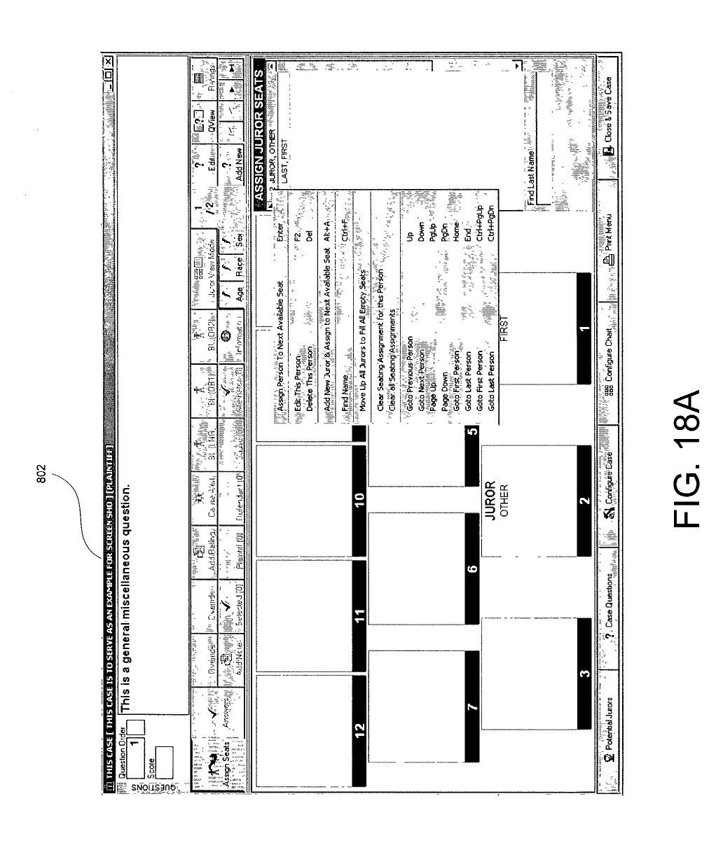

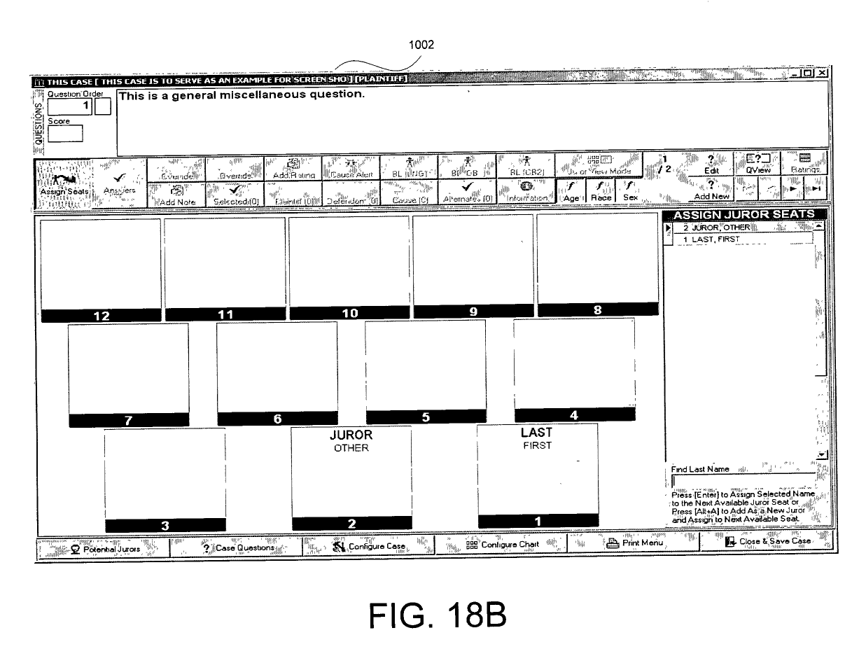

Once the seating arrangement has been established, the jury selection management system 200 may automatically assign a selectable representation to each potential juror based upon his or her respective seating arrangement, as shown, for example, in FIGS. 18A-18B. As the events occur within the courtroom during the jury selection process, the user can automatically select the appropriate representation assigned to each respective jury to enter each potential juror's information.

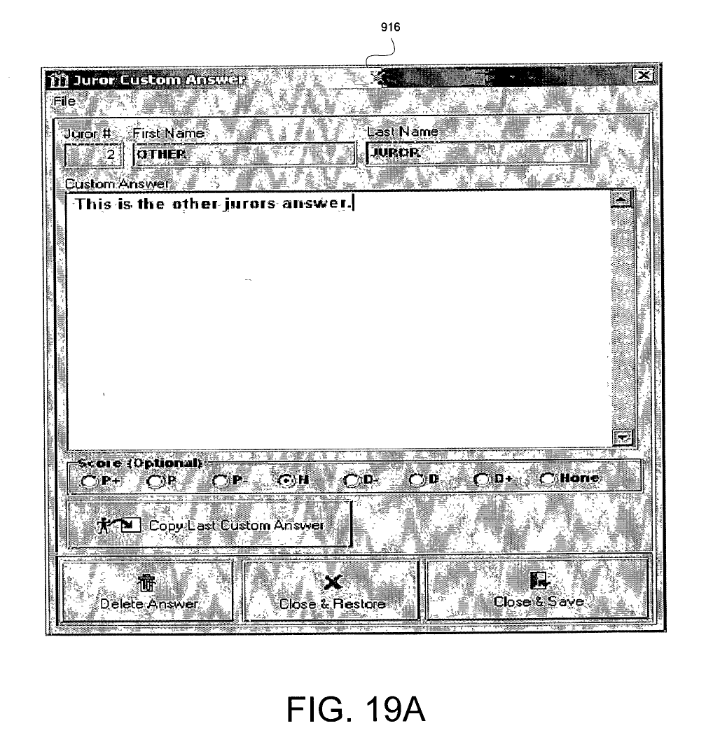

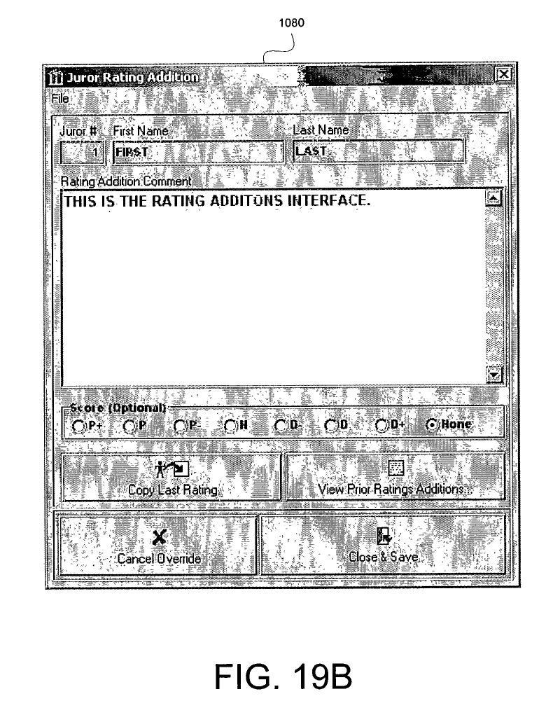

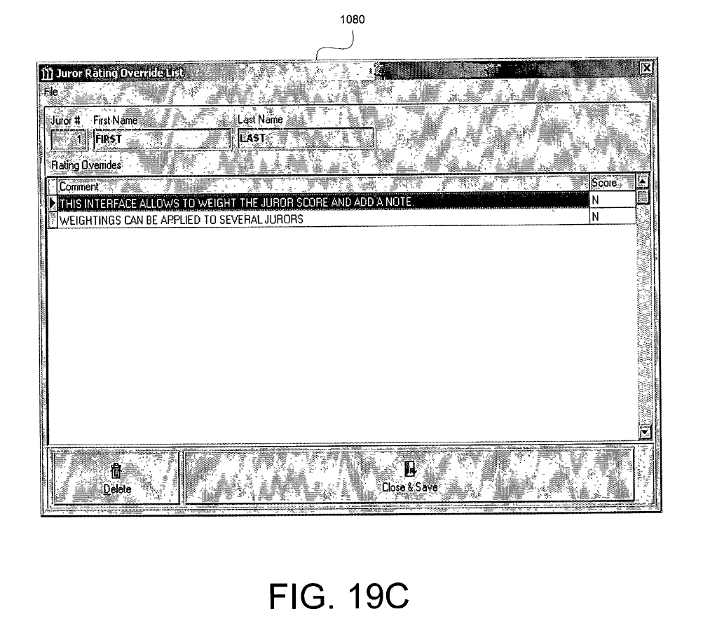

After the potential jurors have been seated and the judge instructs each party to begin questioning the jury panel, the jury selection management system 200 may enable the user to enter any comments or responses provided by each potential juror. If the defense attorney, for example, asks, “How many of you have previously served as a foreperson on a jury?” and seven out of ten members on the panel indicate affirmatively, either by raising their hands or nodding their heads that they have served as a foreperson, the user can input each juror's response. The user may merely quickly activate the selectable representation that represents each potential juror and enter the user's response in the custom answer box shown in FIG. 19A.

The jury selection management system 200 may also be used to record verbal comments made by each juror. If a juror makes a statement that may be considered favorable, for instance, to the defendant's position, the user may input the favorable comment into the jury selection management system 200 so that this comment may be scored and considered by the jury selection management system 200 during its automatic calculation of the selection of the jurors. The jury selection management system 200 may be configured to assign, for example, a favorable score, an unfavorable score or a neutral score to comments made by the potential jurors. As shown in FIGS. 19B-19C, the user may initiate an add rating interface by activating an input dialog box in order to record the comments made by a potential juror and to select a rating to indicate that the comment was favorable for the plaintiff, neutral or favorable for the defendant. The add rating interface may also be configured to display any previous comments made by the potential juror. If more than one potential juror has provided the same response or comments, the add rating may also allow the user to copy the last juror's answer and score and quickly enter this information for a another potential juror.

The invention may also record and track several types of challenges that may be asserted by either party. The jury selection management system 200 may monitor and record the number of challenges asserted by both party and any reasons asserted to support such challenges. The jury selection management system 200 may also recalculate the number of challenges that remain available to each party. For example, the jury selection management system 200 may monitor and record challenges, such as challenges for cause, challenges to a jury array, a general challenge and a peremptory challenge. A challenge for cause is a request from a party to a judge that a certain prospective juror not be allowed to be a member of the jury because of specified causes or reasons. A challenge to a jury is an exception to the whole panel in which the jury is arrayed, based upon an account of partiality. This is a challenge to the form and manner in which the juror panel has been selected. This challenge goes to the illegality of drawing, selecting or impaneling the jury array. Another type of challenge that the invention may monitor is a general challenge, which may be a species of challenges for cause, asserted against a particular juror, to the effect that the juror is disqualified from serving in any case. The decision as to which members of the juror panel a party should assert a challenge against may be analogous to playing a game of chess. Each party attempts to anticipate which members of the juror panel that the other side will disqualify. Thus, the jury selection management system 200 of the invention may assist each party in anticipating the other party's challenges and help each party to devise a strategy in order to select the members of the jury.

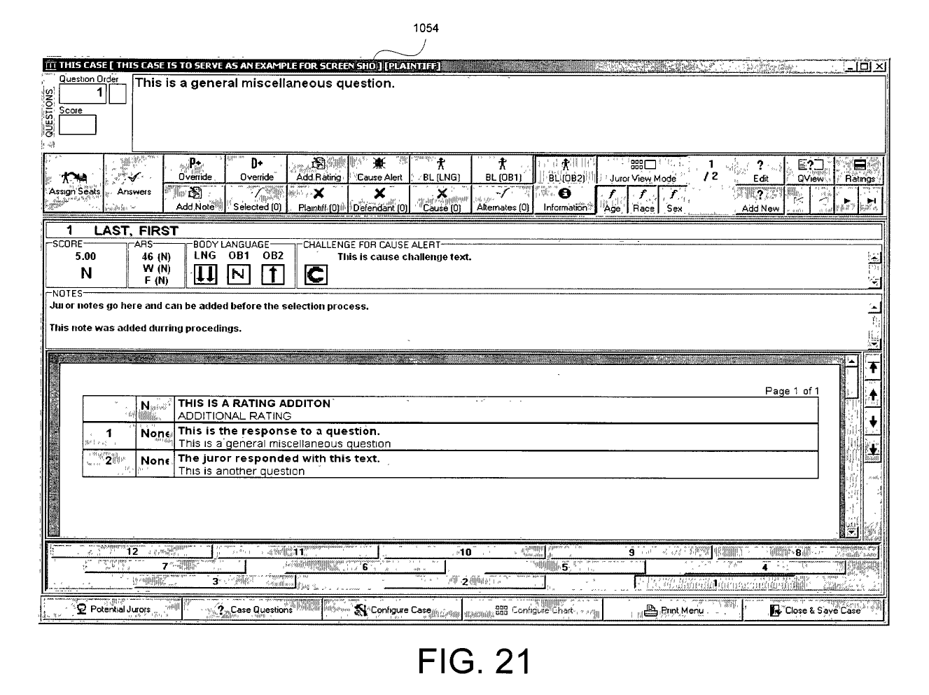

The jury selection management system 200 may also track comments that may be used later by either party to support a challenge for cause. For example, in a liability case against a cigarette manufacturer, if a potential juror states, “I do not think that I can be fair and objective in the present case because my sister died of lung cancer due to cigarette smoking.” The user may input this statement and select an representation to activate a symbol, such as a “C” to appear on display 112 to indicate that the juror has made a statement that can be used to support a challenge for cause, as shown in FIG. 21. As discussed above, a challenge for cause is a request from a party to a judge that a certain prospective juror not be allowed to be a member of the jury because of specified causes or reasons. Thus, in order to dismiss a potential juror based upon a challenge for cause, the challenge must be supported by case law. Thus, this feature, not only allows each party to immediately indicate that a potential juror has made a statement that can be used to support a challenge for cause but also provides case law to support such a statement. Once the challenge for cause statement has been made and entered into the system 200 by the user, the jury selection management system 200 may automatically search its databases to find case law to support this challenge for cause or allow the user to select state specific case law from a list provided by a programmer or built-in by the user.

The jury selection management system 200 may also be employed to track and record peremptory challenges. A peremptory challenge is a request from a party that a judge not allow a certain prospective juror to be a member of the jury. Although no reason or cause is needed to support a peremptory challenge, the number of peremptory challenges afforded to each party is set to a limited number either by statute or court rules. Thus, the jury selection management system 200 may be configured to record each peremptory strike asserted by each party and to inform the user of the number of remaining peremptory strikes that each party has available.

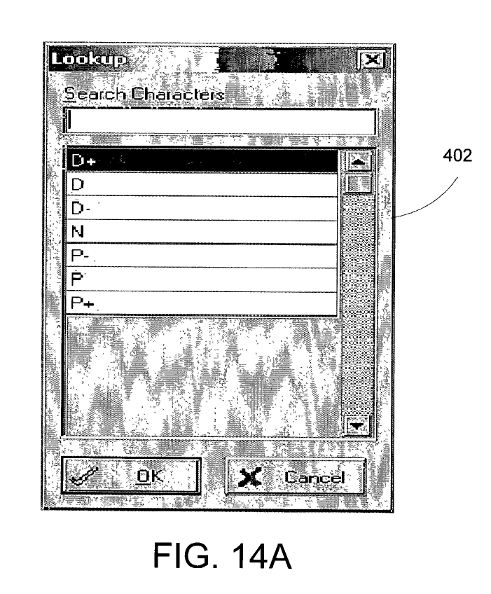

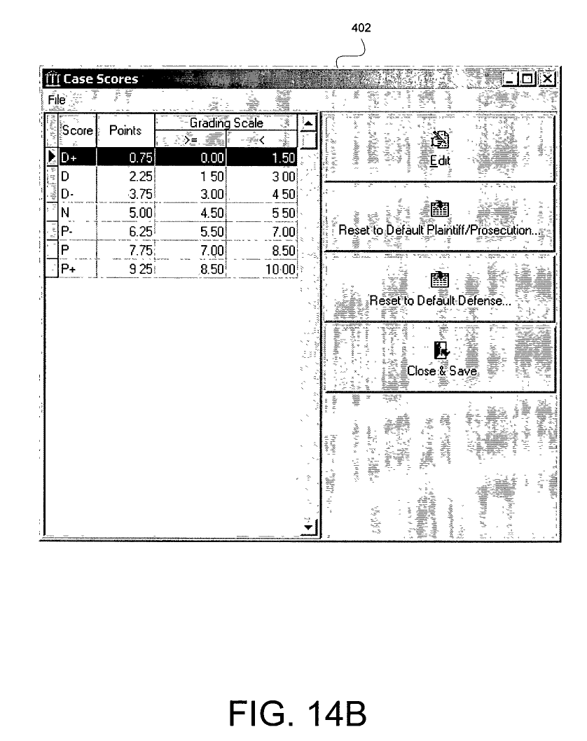

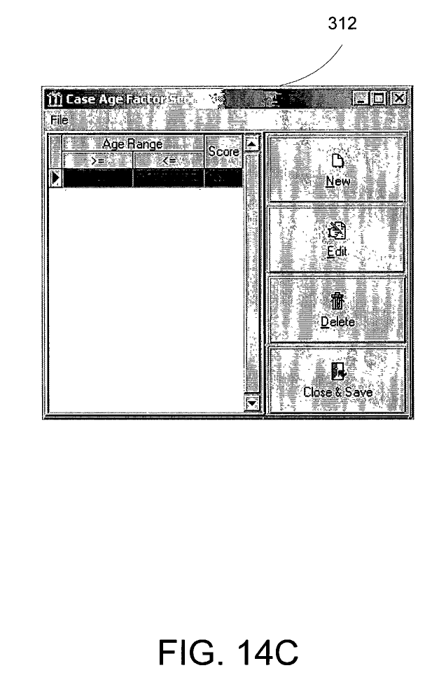

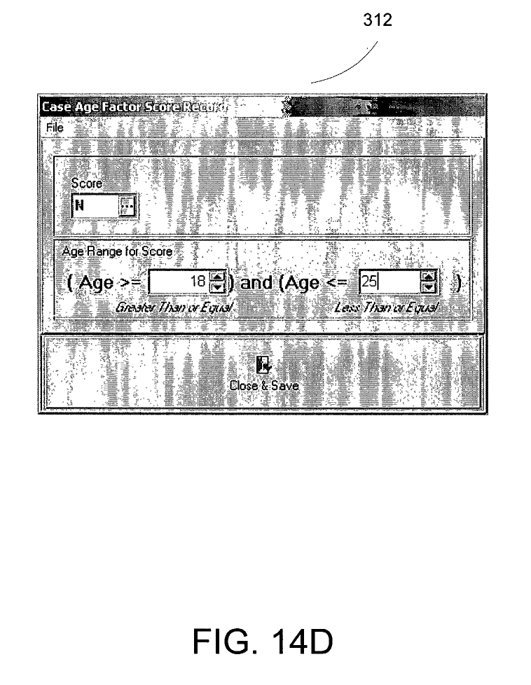

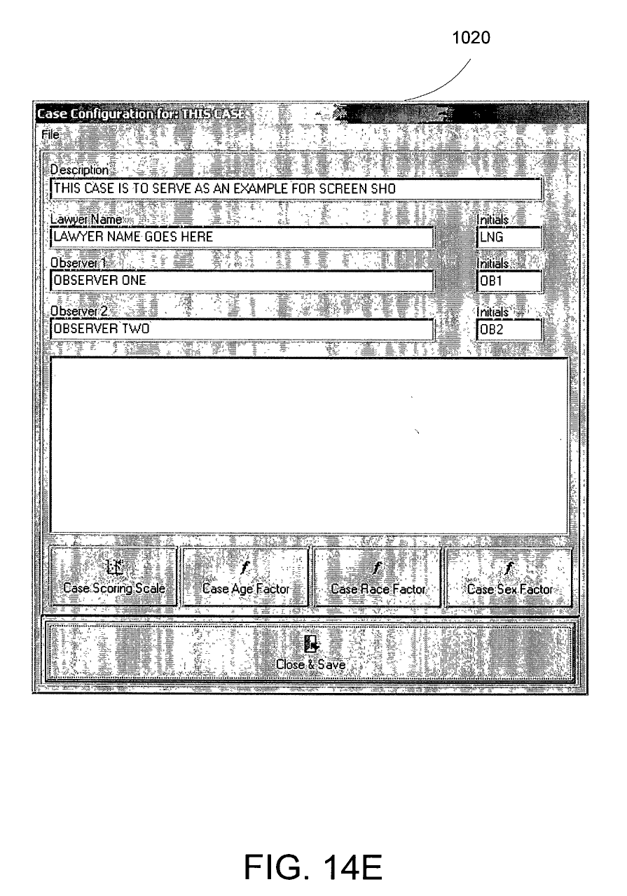

The jury selection management system 200 may also be configured so that demographic and personal characteristics for each juror such as a potential juror's race, sex, age and nationality may be entered and scored within the system as shown in FIGS. 14C-14D. The jury selection management system 200 may be preprogrammed before or during the jury selection to rate each personal characteristic. Therefore, the user may configure the jury selection management system 200 so that one or more personal characteristics may be assigned a score based upon the type of case. In preparing the case, if the defense decides, for example, that jurors who are 65 and over would be more favorable to the defendant, the defense attorney can have this characteristic flagged so that jurors who meet this characteristic will have their scores weighted favorably.

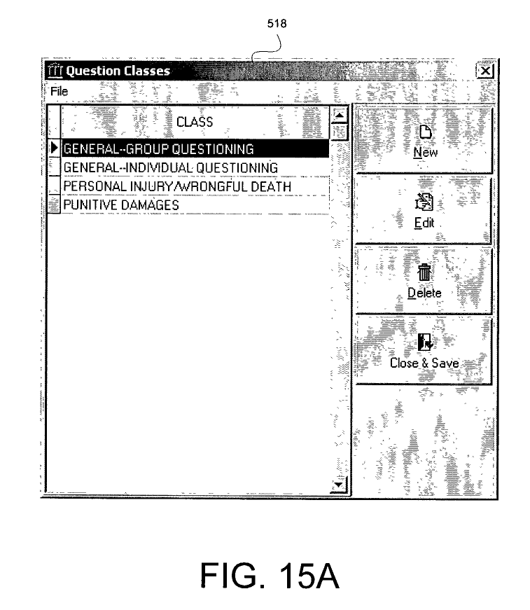

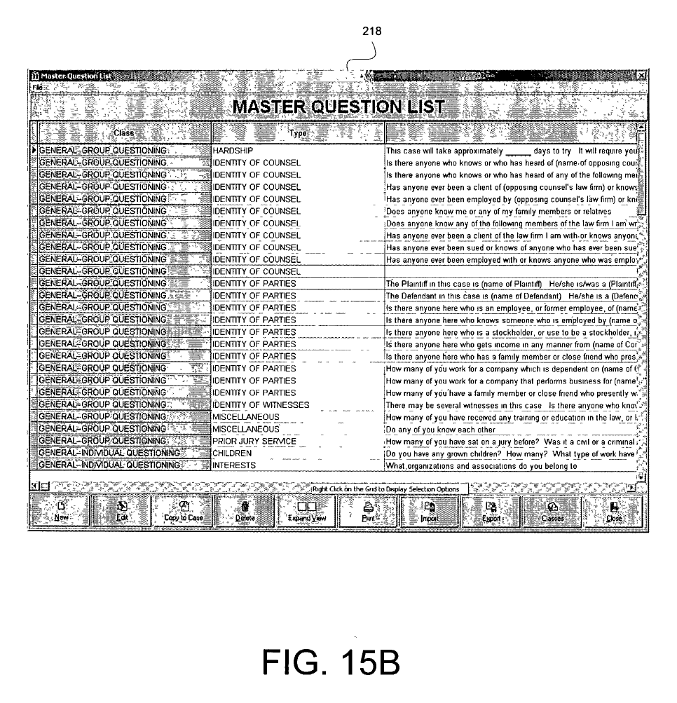

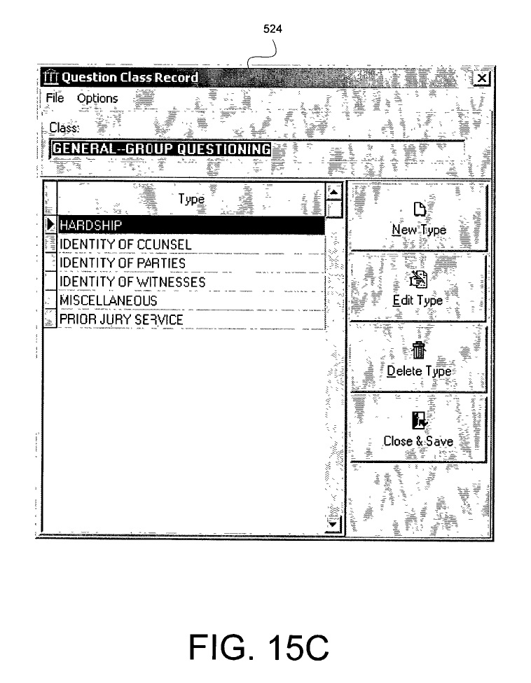

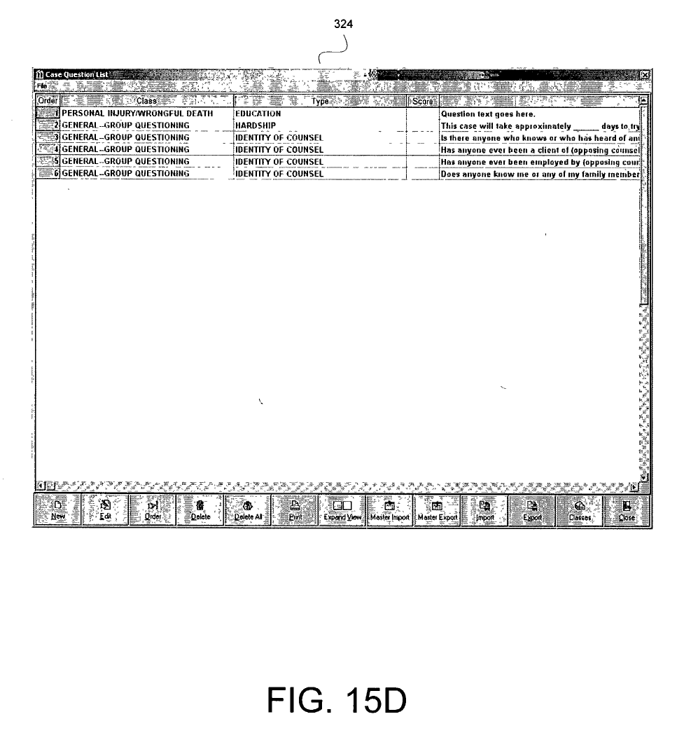

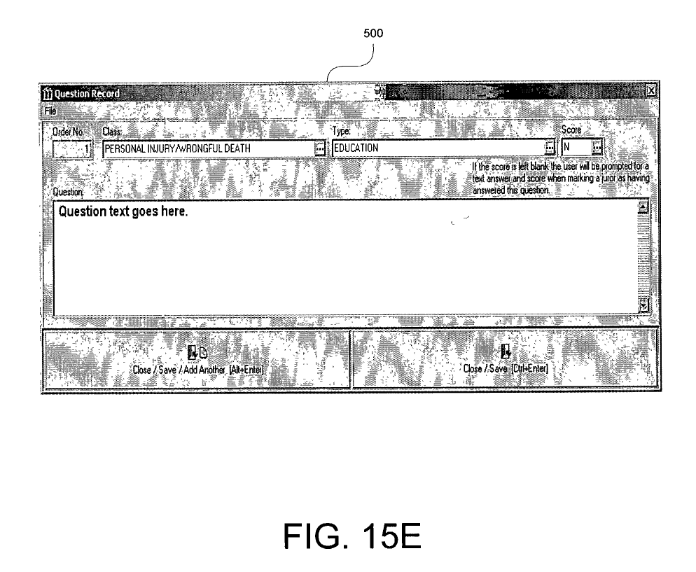

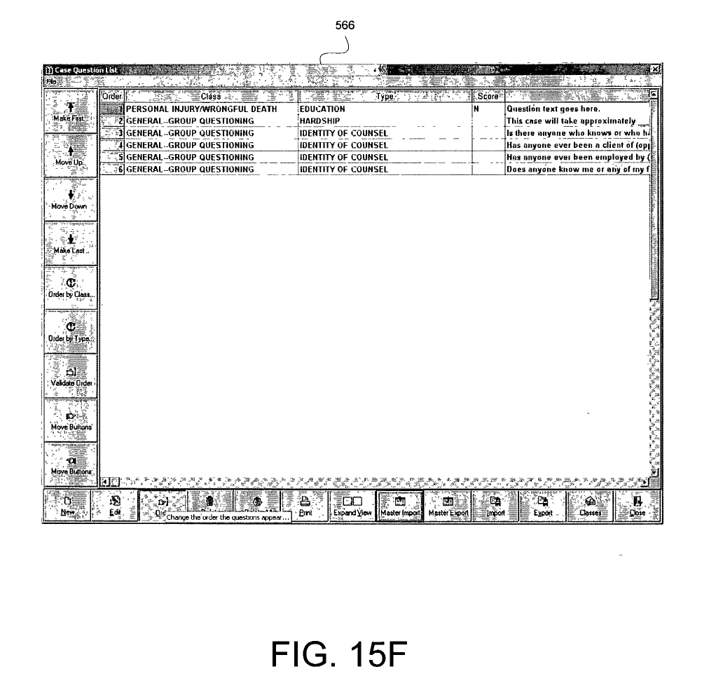

The jury selection management system 200 also may be configured to include one or more question databases, as depicted in FIGS. 15A-15F, which may assist the user in generating questions, that may be used by the attorneys during the voir dire. There may be a master question list (FIG. 15B), which may serve as a central database for the collection of all questions generated, and there may be a case question list (FIGS. 15D-15E), which may contain only the questions that have been selected by a user for a particular case. In preparing for the case, a party may use a case question interface 324 to interface with the master question database of the jury selection management system 200 to select and formulate the questions compiled within the case question list. A party may use its case question list when conducting the preliminary examination of the prospective jurors to determine the prospective jurors' qualifications and suitability to serve as jurors. A party may arrange the questions in the case question list based upon the class and type of questions (FIGS. 15A and 15C) that he or she may wish to ask the jurors panel. Both the master question database and the case question interface 324 may contain questions, which have been previously drafted and stored in the jury selection management system 200. The master question database and the case question database may also assist a user to generate new questions, which may be added to the master question list and/or the case question list. Questions can also be added to both the master case list and the case question list dynamically during the jury selection process.

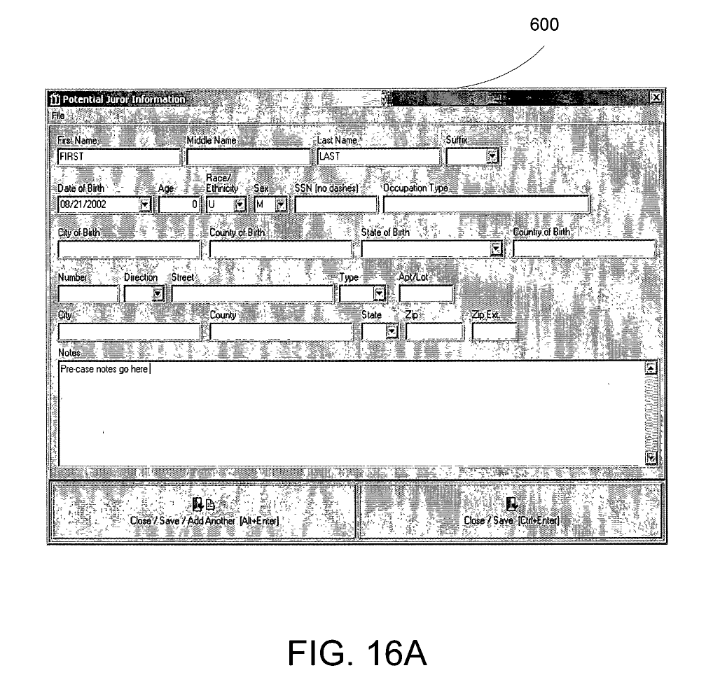

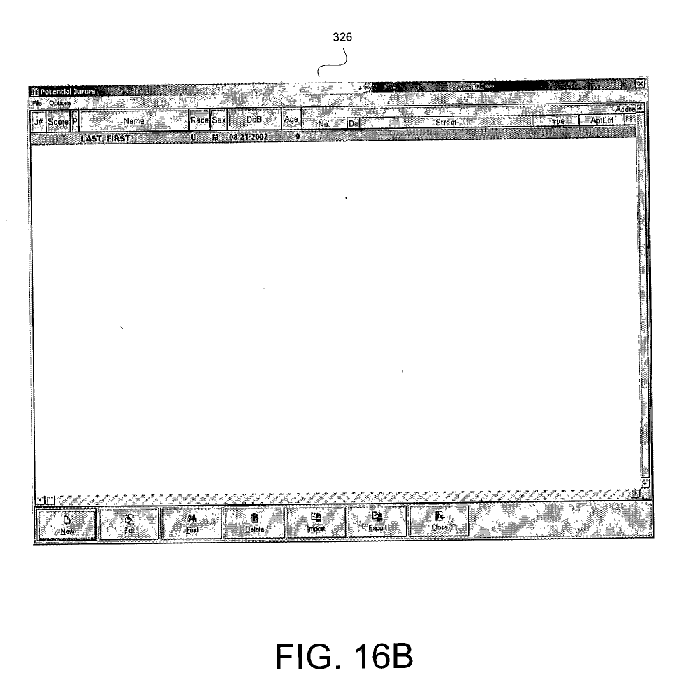

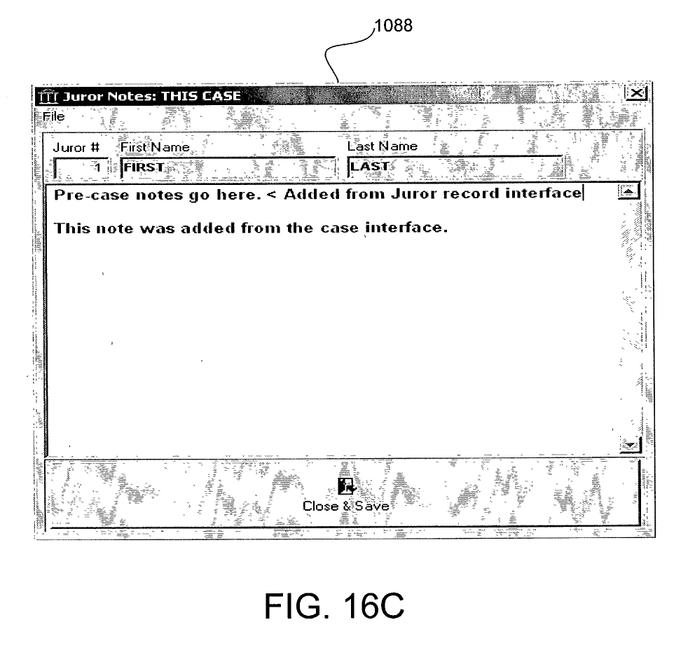

The jury selection management system 200 may further include a background database. Once a candidate's name has been added to the list of potential juror's, the background database may be used to discover background information about each potential juror. The background database may be used to discover information, such as each potential juror's driver's license, criminal record, ownership of property, mortgages, whether the potential juror has obtained any commercial licenses, such as a pilot's license, whether the potential juror has been trained and authorized to carry a concealed weapon, the type of magazines that the potential juror subscribes to, and whether the potential juror has served in the military. The user may configure the background database to perform a search for a specific type of background information. Alternatively, the background database may be programmed to perform a generic background search. The user may also use the jury selection management system 200 to run a real-time background check on a potential juror during the jury selection process. The jury selection management system 200 may automatically conduct the background check and instantaneously provide the user with a background report. The information retrieved during the background search may be inserted within the perspective juror's record and displayed on the display 112, as shown in FIG. 16A. The information retrieved within the background search may also be scored by the jury selection management system 200.

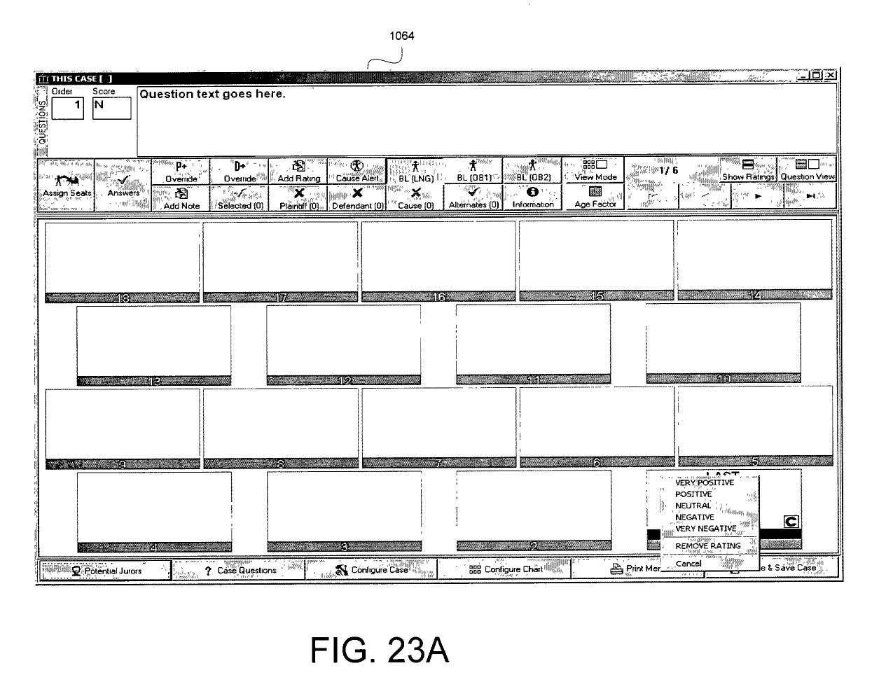

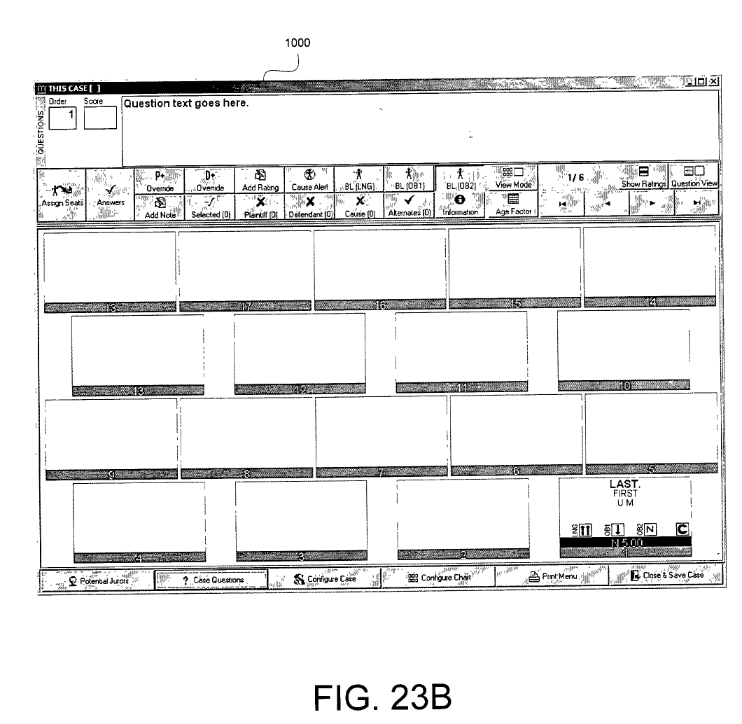

The jury selection management system 200 may also include a body language rating database as illustrated in FIGS. 23A-23B. The body language rating database may permit the user to enter any body movement that a juror may make or exhibit, which may be indicative as to how a juror may vote on the question of the defendant's guilt or innocence. For example, if a potential juror frowns or smiles in response to a question asked from an attorney, the user may manually enter this juror's body language. Alternatively, the user may activate a list or menu and select a selectable representation, which corresponds to the respective body language. The jury selection management system 200 may also be configured to score and rate each potential juror's body language.

In general whether a party represents the plaintiff, prosecution or defense in a legal case, the jury selection management system 200 may create a seating chart and even shift the positions of the seats in the seating chart automatically. In order to assist a party in preparing his or her case, the jury selection management system 200 may allow a user to select from hundreds of jury questions stored in a central database or the user may add new questions to the system. The jury selection management system 200 may also allow a user to instantly and clearly record potential juror responses, demographic information, comments made by a potential juror and body language exhibited by the potential jurors. All data inputs that may be recorded and monitored by the system may be assigned a score. Another feature of the jury selection management system 200 that may be provided to a user is that the system may conveniently display all of the recorded information on a computer screen, for example, of a laptop computer in an easy-to-read chart. The system may also enable a user to print a copy of all of the recorded information in the system in several different formats such as computer-generated charts, listings or as a text printout. The system may also enable a user to flag potential strikes-both preemptory and for cause. The invention may even rank the potential jurors from the most to the least favorable and automatically update the rankings with each juror response.

FIG. 1B provides an exemplary outline of a general overview of some of the tasks that a user may use the jury selection management system 200 to implement prior to the jury selection process. For example, in the pre-selection preparation stage, a user may create a case record (Step 132), prepare and print questions for the potential jurors (Steps 134-136) and enter the potential juror names (Step 138), if available.

FIG. 1C may represent an outline of some of the general tasks that the user may use the jury selection management system 200 to perform automatically and instantaneously during the jury selection process. For instance, in Step 140, the user may configure a seating chart according to the actual potential juror seating arrangement as assigned by the judge. The user may enter and/or assign the potential jurors to the appropriate seats in the seating chart, in Step 142. The system may provide a computer-generated display of the seating chart in Step 144. The user may instruct the system to establish a communication link with a printer in Step 136 in order to generate a printout of the seating chart including the names of each potential juror in Step 148.

In Step 150, the user may use the questions previously prepared during the pre-selection preparation. In Step 150, the user may also generate questions for the potential juror during the jury selection process. Based upon the jurors' answers, response to the questions and demographics, the user may assign a score to the potential juror and/or the jury selection management system 200 may assign a score to the potential juror. The user may then select the members of the jury based upon the juror's profile, notes attached to a potential juror's information and the score assigned to each potential juror.

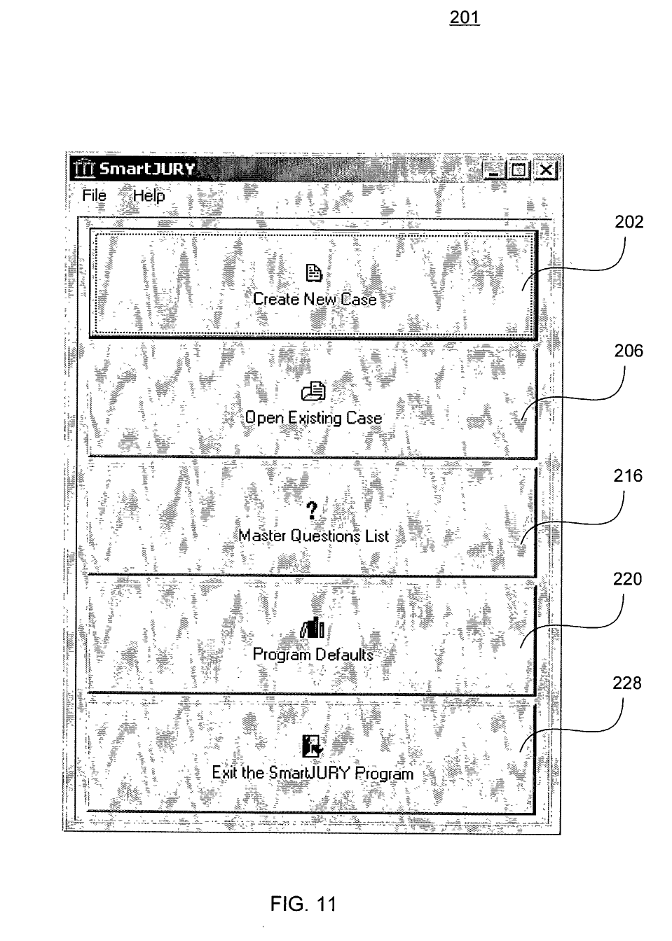

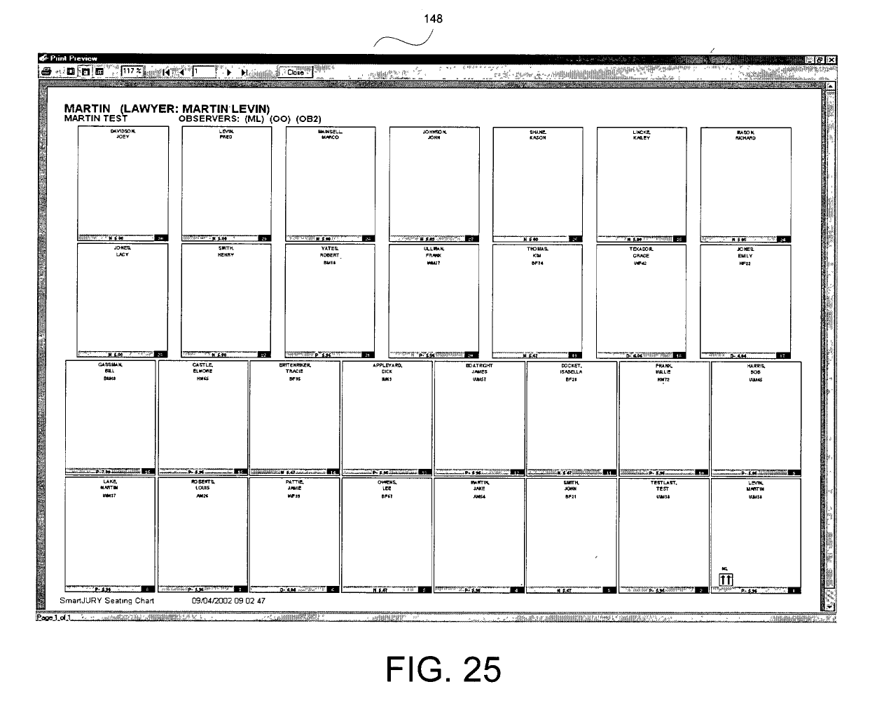

The jury selection management system 200 may be implemented according to the exemplary device as shown in FIGS. 2-25. FIG. 2 illustrates a system that may include components such as a main interface 201, a new case menu 202, an existing case menu 206, a master question menu 216, a program defaults menu 220 and an exit program representation 228. In order for the user to set-up and format the jury selection management system 200 for each case, a start-up menu may be provided to the user by activating the main interface 201. Display screens corresponding to various selectable functions such as create a new case 202, open an existing case 206, establish a master question list 216, establish program default settings 220 and exit the jury selection management system 228 may be displayed when the appropriate functions are selected in the main interface 201, as shown in FIG. 11. Each of the selectable functions may be displayed as extensions to the main interface display, and further options provided by each selectable function can be revealed or hidden by activating toggle option buttons.

In the main interface 201, the new case menu 202 may allow the user to create a file for a new case, and, when selected, may initiate a new case interface 204 that enables the user to enter information regarding the new case.

The existing case menu 206 may allow the user to open a previously created file and retrieve information regarding a case that has been previously established and stored in the jury selection management system 200. Upon activation of the open existing case menu 206 by the user, a select existing case interface 208 may be automatically initiated. The select existing case interface 208 may provide a listing of selectable previously created cases. If the user selects one of the previously created cases, a search of a main case interface 1000 may be automatically initiated to retrieve all information stored in the jury selection management system 200 regarding the selected case. Other option menus provided in the main interface 201 under the existing case menu 206 may include a delete existing case menu 212 and a return to the main interface menu 214. The delete existing case interface 212 may allow the user to delete all or some of the information previously created and stored in the system regarding a specific case. The delete existing case menu 212 may also be used by the user to purge all previously created cases from the jury selection management system 200. The return to the main interface 214 may enable the user to exit these options under the existing case menu 206 and return to the main interface 201.

The master question menu 216 may allow the user to select questions from the question database, edit questions in the question database or add questions to the database. A master question interface 218 may be activated when the master question menu 216 is selected. The master question interface 218 may allow the user to select previously entered questions, to download questions from a website via an Internet connection, download questions from a server or host on a local network, import questions from existing text processing program data files, or to create new questions that may be stored in a case question list and used during the voir dire process for a specific case.

The program default menu 220 may enable a user to store his or her personal preferences, such as the display screen's format. A program default interface 222, which may be configured as a menu extending from the program default menu 220, may be used by the user to establish the user's personal preferences, such as the law firm's name, the attorney's name, the state in which the attorney practices law, state or federal specific configuration options, any options global to the jury selection management system 200 and any other selectable representations. Another feature that may be provided under the program default menu 220 is a master rating settings interface 224, which may permit the user to edit the factors to be considered by the statistical analysis program of the jury selection management system 200 in each case and to edit the score assigned to each factor in each case.

The exit program interface 228 may permit the user to exit the jury selection management system 200.

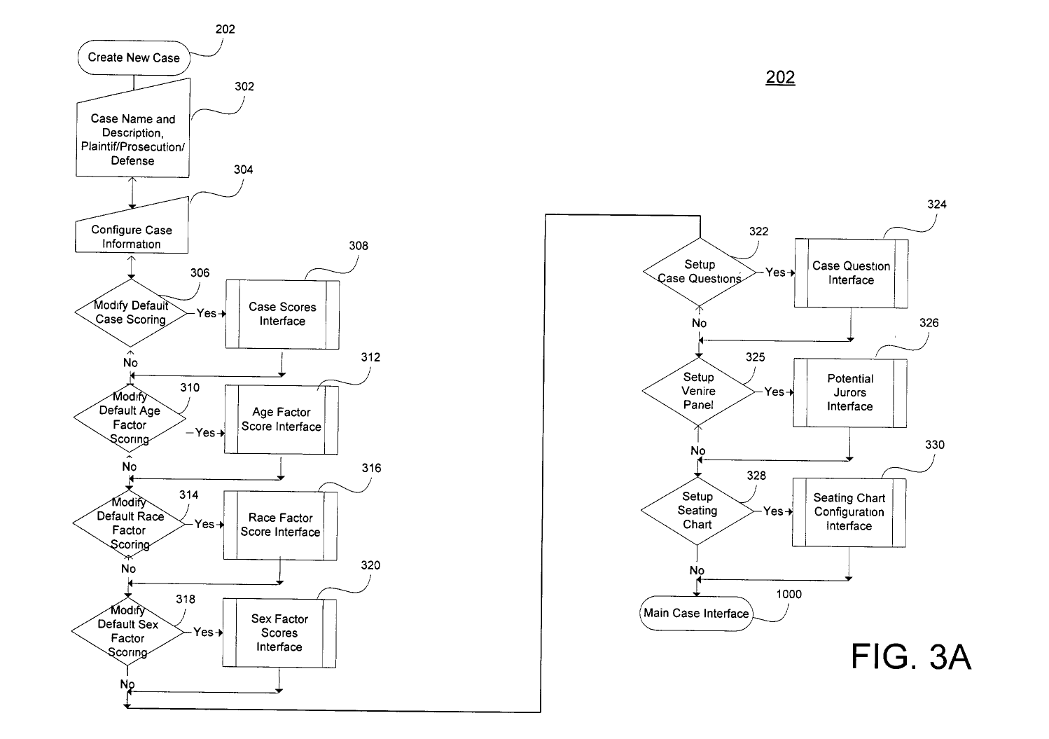

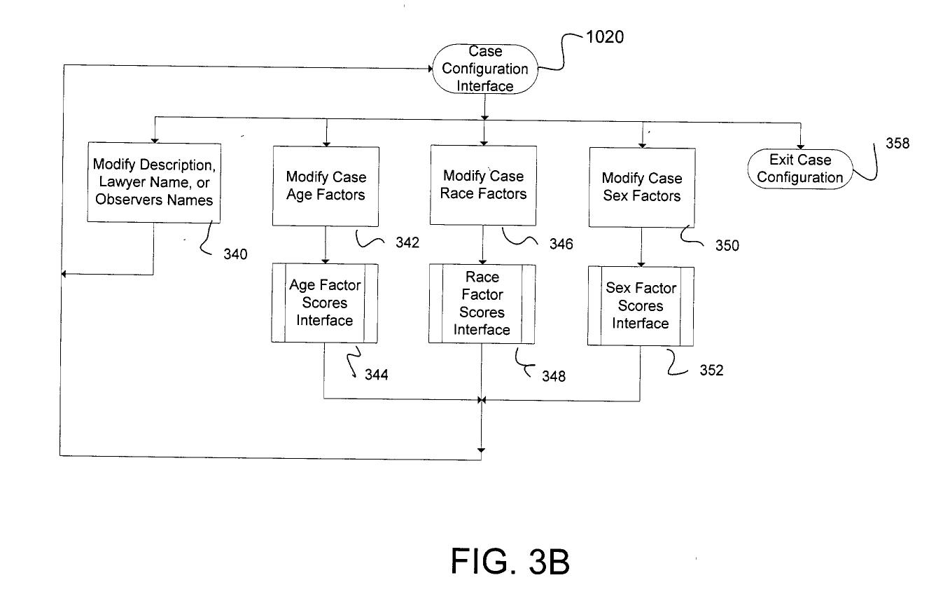

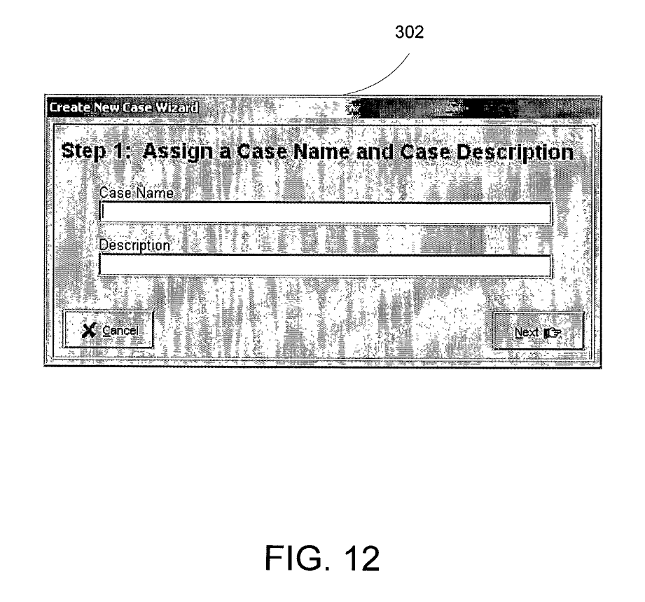

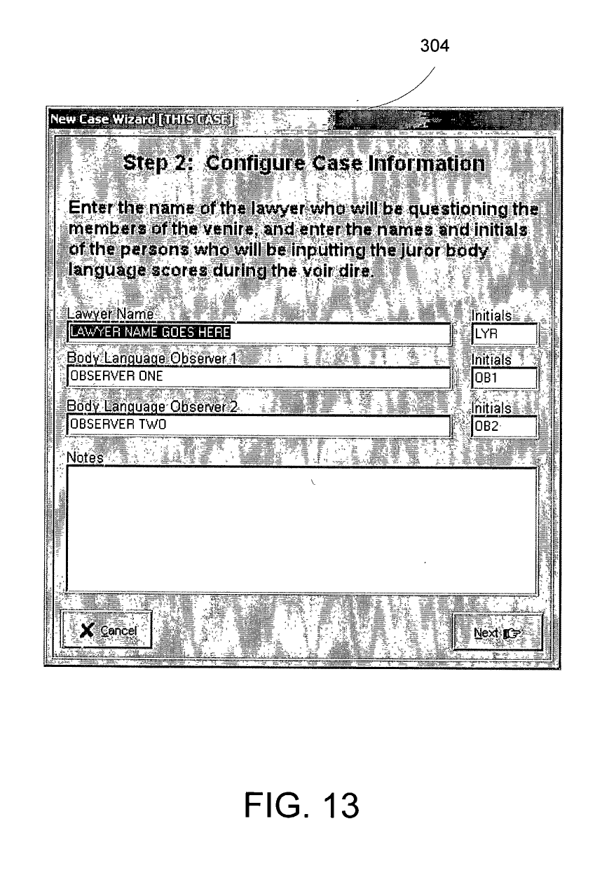

FIG. 3A illustrates further details of the features that may be included in the new case menu 202 to enable a user to create a new case. A user may create a new case by following the exemplary steps outlined in FIG. 3A. For instance, a user may initially assign a case name and case description in step 302 and shown in FIG. 12. Next, the user may configure case information in step 304 and as shown in FIG. 13. The case information may allow the user to enter, for example, the lawyer's name and initials, and at least one or more body language observers. The body language observers may be a party's representative who has been assigned the task of monitoring and recording the jurors' body language. The body language observer may be an attorney, a legal assistant and/or a remote viewer, who is monitoring the courtroom events via a satellite communication as discussed above. Thus, the system may receive several body language actions that may be entered simultaneously by multiple observers.

The jury selection management system 200 may enable a user to preprogram parameters that may be important factors in determining how a potential juror may vote if selected as a member of the jury. The user may initially pre-score or rate at least one or more personal characteristics that may be considered a favorable, unfavorable or neutral trait of a potential juror for either the defendant or the plaintiff. For example, as shown in FIG. 14A, the symbol “D+” may represent a specific characteristic that is strongly favorable for the defendant, the symbol “D−” may represent a specific characteristic that is mildly favorable for the defendant, the symbol “N” may represent a personal characteristic that is neutral to both the defendant and the plaintiff for a specific characteristic, the symbol “P−” may represent a mildly favorable characteristic for the plaintiff, and the symbol “P+” may represent a strongly favorable characteristic for the plaintiff. The symbol “D” may be used to mean a moderately favorable defense oriented characteristic, and the symbol “P” may be used to indicate a moderately favorable plaintiff or prosecution oriented characteristic.

A numerical value, as shown in FIG. 14B, may be assigned to any of the rating symbols shown in FIG. 14A. At the initiation of each case, a party may wish to modify the range of the numerical values assigned to each rating symbol. The modify default case scoring menu in Step 306 may allow the user to establish and modify the numerical values for the rating symbols on a case-by-case basis. Step 306 may enable the user to modify scores or rates that have been previously established for a particular alpha based score rating.

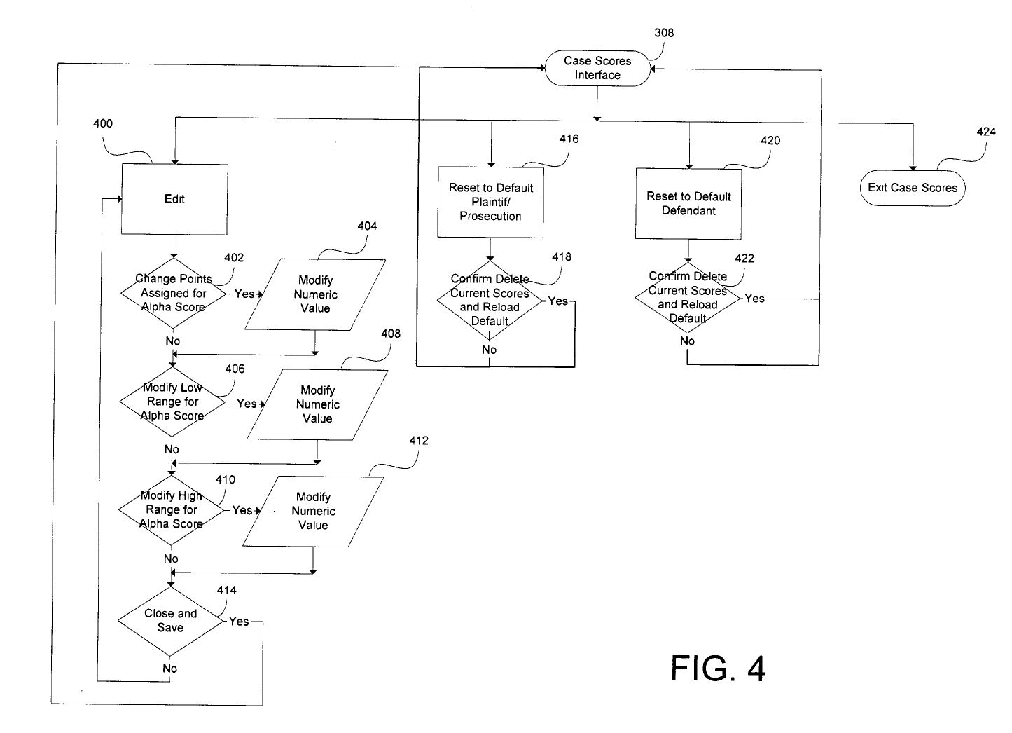

If the user decides to modify, add or delete a score assigned to an alpha based score rating (FIGS. 14A-14B), the case score interface may be activated in Step 308 in FIGS. 3A-4. In Step 400 of FIG. 4, the user can use the case score interface to edit an alpha based score rating. The user may be provided with the options of changing the point value currently assigned to a specific alpha based score in Step 402. If the user decides to modify the numerical value assigned to a personal trait, the system may advance to Step 404. In Step 406, the system may provide the user with the option to modify the low range score for an alpha based score. The system may allow the user to modify the low range score in Step 408. The system also may provide the user in Step 410 with the option of modifying the high range assigned to an alpha based score. If the user chooses to modify the high range, the system may proceed to Step 412. After the user has modified the personal traits, the system may allow the user in Step 414 to save the newly established scores.

In Step 416, the user may reset the configured scores to pre-defined default settings for the plaintiff/prosecution. Step 418 may enable the user to confirm the deletion of the previously set scores and set the scores to the default scores. Similarly in Steps 420-422, the newly established scores may be reset to the default settings for the defendant. Step 424 may enable the user to exit the case score interface and return to the new case menu 202, shown in FIG. 3A at Step 310.

In FIG. 3A, the system may employ a process similar to the steps outlined in FIG. 4 to allow the user to modify, for example, the default scores for a potential juror's age (Steps 310-312), the potential juror's race (Steps 314-316), and the potential juror's sex (Steps 318-320).

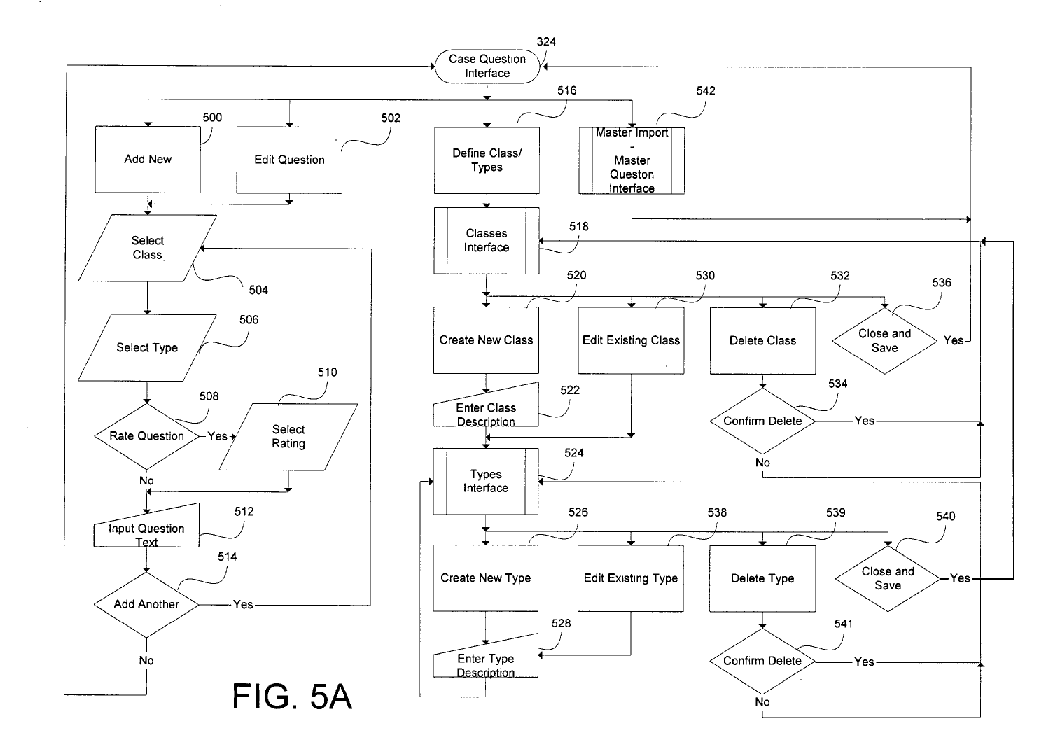

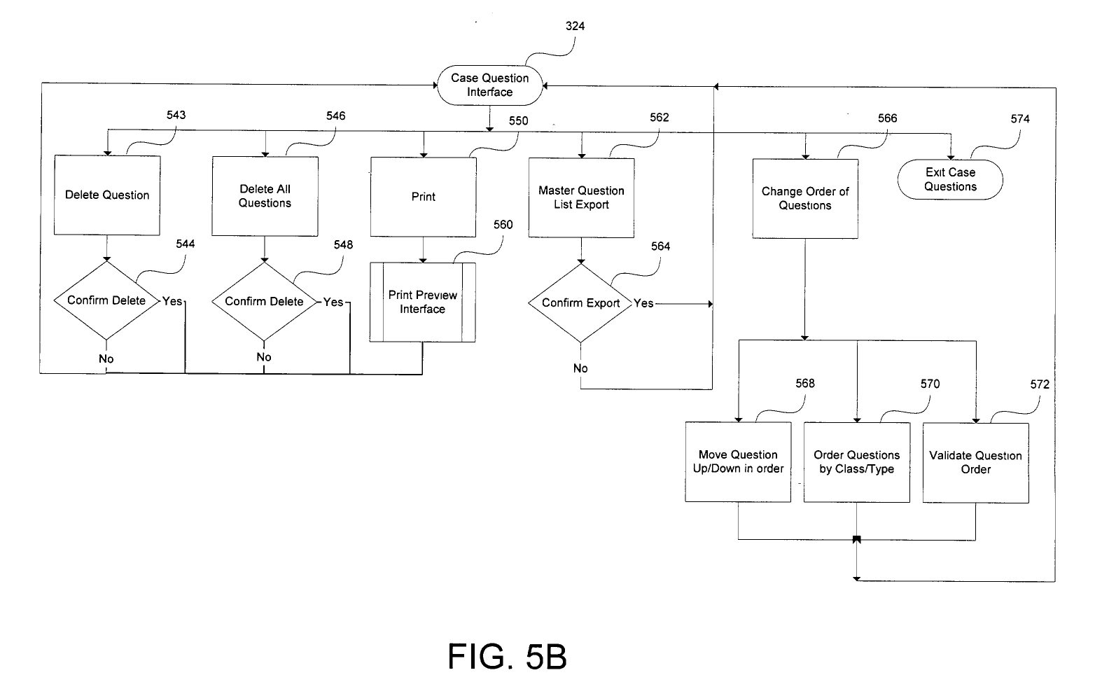

Next, the user may continue to pre-configure the parameters of the new case by setting up the case questions in Step 322 of FIGS. 3A and 5A-5B. The case question interface 324 may allow the user to import and/or manually enter questions that may be asked of the potential jurors during the voir dire. The user may also pre-configure the new case so that the questions selected or generated may be assigned a score. In FIG. 5A, the case question interface may allow the user to add a new question to the new case in Step 500, to edit a previously generated question in Step 502, define new classifications (Step 520) and types of questions in Steps 524-540, and to import questions from a master question interface (Step 542). The system may provide the user with a screen display as shown, for example in FIG. 15E, to enable the user to add a new question in Step 500 and to edit a previously generated question in Step 502.

In Step 504 and as shown in FIG. 5A, the user may select the class of the question. The user may select a class of questions from a master question list (FIG. 15B). The master question list may contain questions that have been previously drafted and stored in the jury selection management system 200. The jury selection management system 200 may also allow the user to establish a connection to the Internet, to another computer or to another electronic device and perform database searches to assist the user in creating the case question list. The class of the question may be directed to a “general” question that may be presented to all the members of the juror pool, as illustrated in FIG. 15A. In addition, the user may select a classification related to a “general” question that may be directed to a specific individual of the juror pool. In Step 506, the user may select the type of question based upon a classification of the question. In FIG. 15C, the user may select from a “general-group questioning” classification a question type that relates to “hardship.”

In Step 510, each question may be assigned a score using the rating system, for example, as shown in FIG. 14A. For example, in FIGS. 15E-15F, the personal injury/wrongful death question has been assigned a neutral rating which is indicated by the symbol “N.” Step 512 may provide the user with a text box to input question text. Step 514 may allow the user to add another question to the new case.

Selection of the define class/type menu, in Step 516, may automatically cause the system to activate the question class interface. A user may create a new class in Step 520 by entering a new class description (Step 522) in a text box presented by the interface in Step 522. The user may also edit an existing class (Step 530), and/or delete a class (Step 532). If the user chooses to delete a class, as a precautionary measure, the invention may include a safety check to confirm that the user intended to delete the selected class. In Step 536, the user may close and save all actions taken to create, modify or delete a class. Similar to the steps taken to create a new class discussed above, a user may create a new question type, edit an existing type, and/or delete a type in Steps 526, and 538-540.

Additional features that may be included in the case question interface 324 may include a delete question feature in Step 543, a delete all question feature in Step 546, a master question list export in Step 562, and a change order of question in Step 566. The delete question button, in Step 543, may allow a user to select one or more questions and delete these selected questions. The confirm delete button in Step 544 may be provided as a safety precautionary measure to prevent the user from inadvertently deleting a question. The delete all questions button provided in Step 546 may be included in the system to allow the user to quickly delete all previously stored questions. Similarly, a confirm delete button may be provided to prevent the accidental deletion of all the questions stored in the jury selection management system 200.

In Step 550, the case question interface also may enable the user to perform administrative features such as print out a listing of the questions that the user has selected and compiled for a particular case. Activation of the print button in Step 550 may instruct computer system 100 to establish a communication with a device such as printer, scanner or a facsimile machine in order to generate a printout of the selected questions. The print preview interface 560 may allow the user to preview the questions on display 112 before generating a printout.

The master question list export 562 may allow the user to employ the case question interface to select questions that have been previously generated or entered by the user and copy them to the master question database.

The jury selection management system 200 may also be configured to enable the user to rearrange the order in which the questions are displayed on display 112 in Step 566. The user may activate selectable representations, as shown for example in FIG. 15F, to move a question either up or down in Step 568 and to arrange the questions by class, type or according to the user's preference in Step 570. The change of order feature in Step 566 may allow the user to arrange the questions in advance of the trial. The change of order feature in Step 566 may also be used dynamically during the jury selection process to arrange the questions as the events occur within the courtroom. The user may also use the change of order feature in Step 566 to arrange and assign the order of questions that are presented to each potential juror. The newly arranged order of questions may be confirmed by the system in Step 572. Once the user has selected and formatted the questions, the user may exit the case question interface in Step 574 and return to Step 325 in the new case interface in FIG. 3A.

As discussed above, prior to the jury selection process, each party may receive, from the court, a list containing the names, for example, of approximately 300 potential jurors. The potential juror menu, in Step 326, may allow the user to enter the names of the potential jurors and perform a background check on each potential juror in advance of and during the jury selection process, as shown in FIGS. 16A-C. The system may use the potential juror interface shown in FIGS. 3A, 6 and 10 to input information (Step 600 and shown, for example, in FIG. 16A) such as a potential juror's name (Step 610), age (Step 612) or any other additional information deemed pertinent to the case (Step 614). In Step 612, the user may enter either the potential juror's age or date of birth. In Step 622 will automatically calculate the potential juror's age if the user enters the date of birth in Step 612. The jury selection management system, in Step 616 and FIGS. 16A and 16C, may also permit the user to add notes or comments regarding each potential juror. The system may be configured so that entry of the potential juror's information in Step 618 may be an iterative process. The potential juror's information may be entered into the system manually, electronically or through a wireless communication connection. For example, a user may manually type in a potential juror's information. Alternatively or in conjunction, the potential juror's information may be entered through a connection established via the Internet or with another electronic device. The potential juror's information may also be sent from a wireless communication device and downloaded automatically to the jury selection management system 200. Once a potential juror's information has been entered into the system, Step 620 may allow the user to edit the potential juror's information. The system may provide the user with a similar screen display as shown, for example, in FIG. 16A to enable the user to edit the potential juror's information in Step 620.

The system may also permit a user to search a juror list database to locate a juror's records in Step 624 by entering a juror's name in Step 626. This feature may enable the system to maintain a database of previously selected jurors or potential jurors. If the name of a potential juror, who has previously served on a jury, participated in a juror selection process or participated in any aspect of a legal case in any jurisdiction, appears on the list for the juror pool in a subsequent case, the jury selection management system 200 may automatically search a database and retrieve all information previously stored regarding this potential juror. For instance, the jury selection management system 200 may retrieve any statements, body language gestures, or votes made by the potential juror in a previous case.

The jury selection management system 200 may access one or more databases to search for information regarding a potential juror. The jury selection management system 200 may provide a collective database, which may be searched to locate information regarding a particular potential juror. The collective database may be established by compiling several juror databases generated by one or more users in various jurisdictions. For example, if a potential juror in a Florida case served on a jury in North Carolina and voted against a pharmacy company, the jury selection management system 200 may be able to retrieve and add this information as a note to the potential juror information, as shown in FIGS. 16A and 16C.

Step 628 may permit the user to delete any juror from the juror database, and Step 630 may serve as a safety precaution for preventing the user from accidentally deleting a juror's information. Step 632 may be provided by the system to allow the user to exit the potential juror screen and return to the seating chart configuration in Step 328 in FIG. 3A.

During the jury selection process, the jury selection management system may allow the user to quickly configure any possible seating arrangement for any possible number of jurors, in Step 328. By selecting the seating chart button in Step 328, the system may automatically activate a seating chart configuration interface in Step 330. The seating chart configuration interface in Step 330 may allow the user to develop a seating chart. After the potential juror's seating arrangement has been assigned, if any of the potential jurors are asked to leave the juror panel, change seats or if the seating arrangement is altered for any reasons, the jury selection management system 200 may enable the user to dynamically rearrange the seating arrangement within the virtual seating chart.

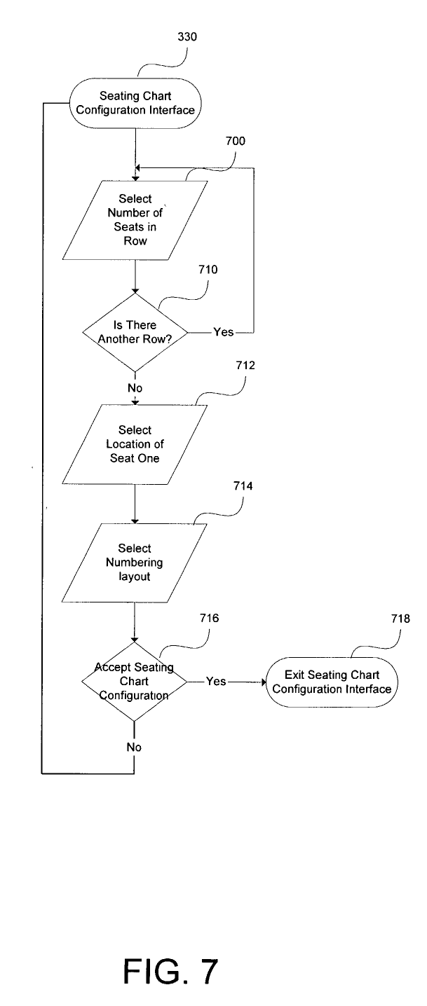

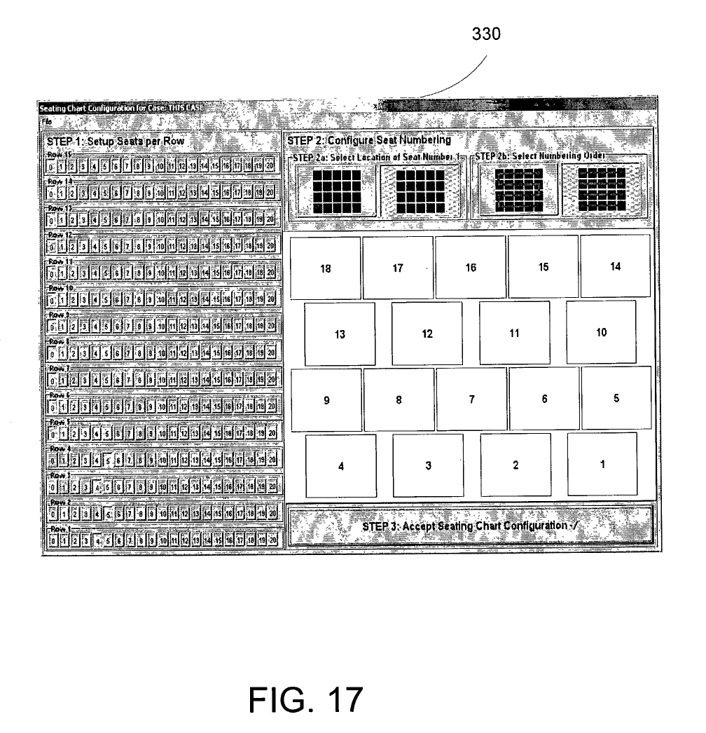

In Step 700 of FIG. 7, as the judge assigns the seating arrangement, the user may define the number of seats that may be assigned to each row. For example as shown in FIG. 17, if the judge instructs that there will be four potential jurors seated on the first row, five potential jurors seated on the second row, four potential jurors seated on the third row and five potential jurors seated on the fourth row, the user may automatically select the appropriate number of seats in Step 700. The user may continue to select as many rows as needed in Step 710.

Step 712 may allow the user to initiate the setup of the numbering layout by defining the location of the first seat, i.e. “seat one” as arranged by the judge. The system may use the “seat one” position to plot the numbering layout for the remaining seats in Step 714. In FIG. 17, the numbering layout starting from “seat one” may be configured to resemble, for example, a zigzag configuration, several horizontal rows extending either left-to-right or right-to-left, several vertical rows extending either front to back or back to front or any other configuration. The user may accept the seating chart configuration in Step 716. The user may exit the seating chart configuration in Step 718 and return to the main case interface 1000 as shown in FIG. 3A.

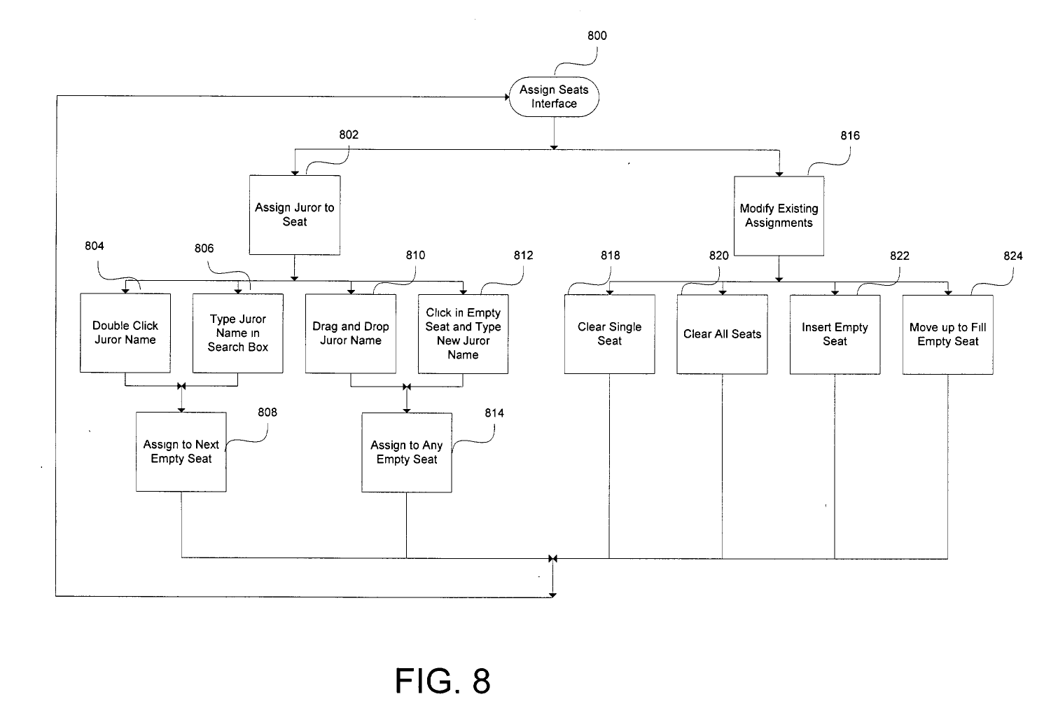

During the jury selection process as the potential jurors enter the courtroom, the user may automatically configure each potential juror's seating assignment by using the assign seat interface in Steps 800 and 802 in FIG. 8 and illustrated in FIG. 18A. As the potential jurors take their seats, the juror selection management system may allow the user to automatically select a user's name previously entered into the system (Steps 804, 806 and 810) or to manually enter a juror's name (Step 812) into a corresponding box on the display screen 112, as shown in FIGS. 18A and 18B. The user may assign the potential juror to any available seat in Step 814 by dragging the potential juror's name from a selectable representation and moving the juror's name to an empty box representation in Steps 810 and 814. Alternatively, the user may merely click on an empty box representation and type in the potential juror's name in Steps 812 and 814.

If the positions of the jurors change for any reasons after the judge has established the original seating arrangement, the user may prompt the system to quickly modify the existing seating arrangement in Step 816. The system may provide the user with several ways to modify the existing seating arrangement. For example as illustrated in FIG. 18A, the user may clear a single seat (Step 818), clear all seats (Step 820), insert an empty seat (Step 822) and/or move all potential juror's positions to fill an empty seat (Step 824).

Once the voir dire process begins, the user may enter the question mode in order to rate and grade the responses received from the potential jurors in Step 900. The user may select, in Step 910, the question to be asked from the question database. The user may select, in Step 912, the potential juror who responds to the question. The respondent may be selected by selecting the potential juror's corresponding seat as shown on the display 112 in FIG. 23B. The user may either manually or electronically record the potential juror's response in Step 916. Step 916 may allow the user to save the potential juror's response.

As shown in FIG. 19A, the user may rate or grade the potential juror's response by assigning, for example, a letter grade which may represent a number grade on a grade scale. If the user wishes to grade the potential juror's response in Step 918, the user may use the grading system depicted in FIGS. 14A-14B to grade or rate each response in Step 920. The system, as shown in FIG. 19A, may allow the user to designate that several jurors have responded to the same question in Step 922. For example, if a defense attorney asks a general question directed to the entire juror pool and three members of the juror pool answers affirmatively, in Step 922, the user may select the next juror. When there are several jurors that provide the same response to the same question, Step 924 may allow the user to enter the same response as the previous response to all of the respondents by copying the last response and rating in Step 926 and as shown in FIG. 19A. The score for each potential juror may automatically be calculated by the system any time an entry is made in the system that alters the potential juror's rating.

The user may decide to bypass several of the preparation features of the main interface 201 and to quickly access the features of the main case interface 1000. As shown in FIG. 2, a user may access the main interface by opening an existing case in Step 206. Several features implemented in the main case interface 1000 are similar to some of the features available in the main interface 201.

The main case interface 1000 may be displayed on display 112 having one or more selectable representations. The selectable representations may include, for example, an assign seats button (Step 1002), an answers button (Step 1006), a potential jurors button (Step 1010), a case questions button (Step 1014), a configure case button (Step 1018), a print menu (Step 1022) and a configure chart button (Step 1026). The term “button” as used in this discussion may mean “a selectable object in a computer that instructs the computer to perform a task, such as display a subsequent screen, activate an interface or perform a calculation, when the button is clicked or activated.” The user may select the assign seats button, which in turn activates the assign juror seats interface in Step 1004. The assign juror seats interface 1004 may allow the user to assign potential jurors to locations in the seating chart as outlined in FIG. 8 and illustrated in FIGS. 18A-18B.

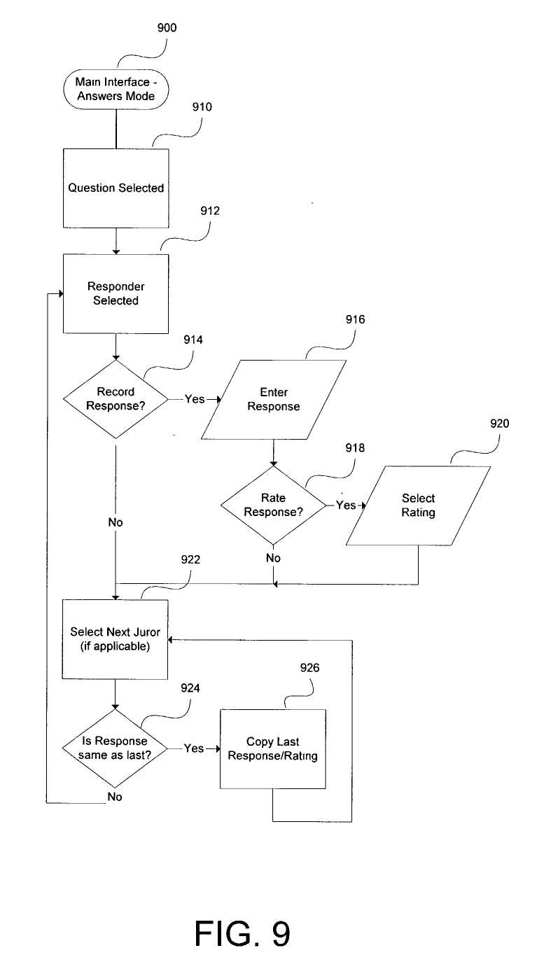

The answers button in Step 1006 may allow the user to record and grade any responses received from the potential jurors, as discussed with reference to FIG. 9 and illustrated in FIG. 19A. The question/response interface in Step 1008 may permit a user to enter notes in each box representing a member of the juror panel. Favorable responses, unusual answers, and relationships that might affect the potential juror's decision may be quickly and clearly entered using the question/response interface in Step 1008.

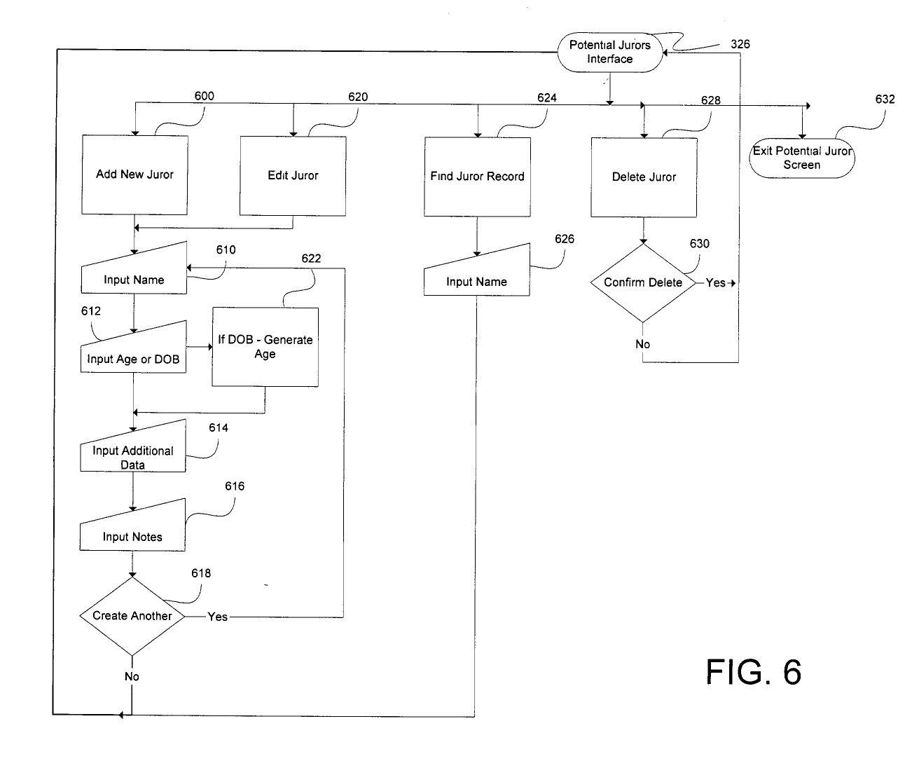

The potential juror button in Step 1010 may allow the user to enter the potential juror's name and conduct a background search of a potential juror during the jury selection process. The potential jurors interface in Step 1012 may use a similar process as explained above with reference to FIG. 6 and illustrated in FIGS. 16A-16B to compile personal information regarding each potential juror. Activation of the potential juror interface 1012 may automatically cause the jury selection management system 200 to perform a background search on any potential juror who is added to the potential juror listing. Once a candidate's name has been added to the list of potential jurors, the background database may be used to discover background information about each potential juror, as discussed above. Notes regarding a potential juror's background may be added to in the “notes” box shown in FIGS. 16A and 16C.

The user may select the case question button in Step 1014 to formulate questions that may be presented to the entire juror panel or to a particular potential juror. The user may choose from hundreds of predefined or user created case-appropriate questions and quickly import the questions from a master question list into a numbered case question list that can be used in questioning the potential juror as shown in FIGS. 15D-15F and outlined in FIGS. 5A-5B. The question list can be modified, added to and printed out at any time. In Steps 1014-1016, the system may use the method discussed in Steps 500-572 to permit the user to quickly arrange the questions according to categories, rate the question and designate a question to be directed to a particular potential juror or the entire juror panel.

In the main case interface 1000, the system may follow Steps 302-320 outlined in FIG. 3A to configure the case in Step 1018. By selecting the configure case button in Step 1018, the case configuration interface 1020 may be initiated to enter general information regarding the name of the case, the names of the parties involved in the case and the attorney's name. The case configuration may also be used to score certain demographic or personal characteristics. The case configuration interface 1020 may be activated by the system to assign a rating to each demographic group or personal characteristic of the jurors as shown in FIGS. 14C-14D. The case configuration interface 1020 may be used to rate personal characteristics or demographics of the potential jurors, to rate the questions selected by the user, to rate the body language exhibited by the potential jurors, and to rate the potential juror's response to the questions.

Alternatively and conjunctively, after a new case has been saved into the system, the case configuration interface 1020 as shown in FIG. 3B may be used to modify the information entered into the system in Steps 302-320 in FIG. 3A. In Step 340, the user may modify the description of the case, the lawyer's name, and/or the observers' names as shown in FIG. 13. The user may modify the personal characteristic such as the age factors (Steps 342-344), the race factors (Steps 346-348) and the sex factors (Steps 350-352). The exit case configuration 358 may allow the user to exit the case configuration interface 1020 and return to the main case interface 1000.

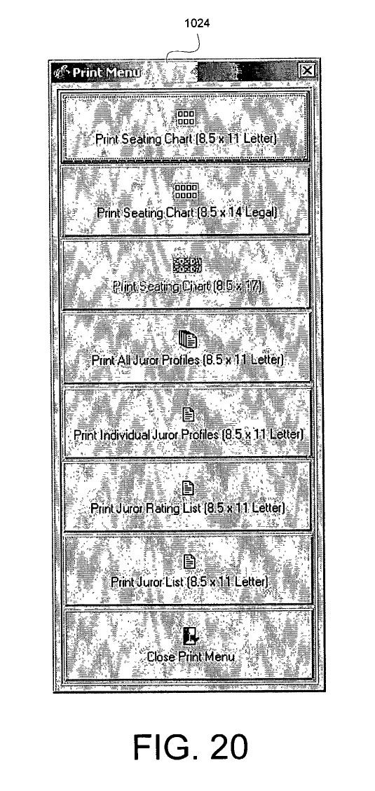

At any time, the user may select the print menu in Step 1022 to generate a printout of several types of information generated by the jury selection management system 200. In Step 1024 and as shown in FIG. 20, the case print interface 1024 may permit the user to receive a printout of information such as the seating chart, a profile of all of the jurors, a profile of an individual juror, a juror rating list, and a juror list.

To configure the seating chart in Step 1026, the main case interface may implement the steps outlined in FIG. 7 and depicted in FIG. 17. The jury selection management system 200 may employ the configure seats interface 1028 to construct a virtual seating chart during the jury selection process. The jury selection management system 200 in Steps 1026-1028 may automatically configure any possible seating arrangement for any possible number of jurors. The invention may also be used during a trial to dynamically construct a virtual jury box and replicate the seating position of any other participant in the courtroom such as the judge, opposing counsel and any courtroom employee.

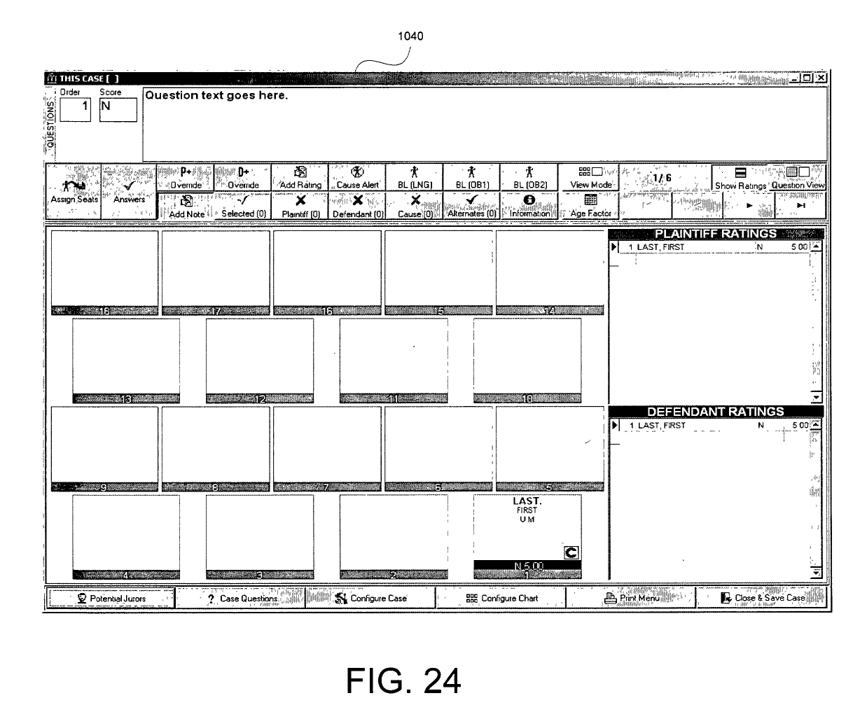

In Steps 1030 of main case interface 1000, the system may employ steps similar to the steps 600-620 outlined in FIG. 6 to use the juror information interface in Step 1032 to enter personal characteristic information about each juror. During the jury selection process, the user may select the question view menu in Step 1034 to activate the question view interface in Step 1034 so that the user and/or members of his or her team can view the questions to be asked during the voir dire individually or in a list format. A ratings menu may be selected in Step 1038 to initiate the toggle ranked ratings view in Step 1040 depicted in FIG. 24. The ranked rating view may permit the user to view a listing of potential jurors sorted by the jury selection system 200 generated score.

The user may select, in Steps 1042-1044, the demographics application menus to toggle the application of scores applied to the potential jurors' demographics, such as age, race and sex.

As the events unfold in the courtroom, should the user wish to edit or add a new question to the case list questions or the master question list database, the user may select the edit question menu in Step 1046 or the add new question menu in Step 1050. Activation of either the edit question menu in Step 1046 or the add new question menu in Step 1050 may automatically initiate a question record interface in Step 1048, which may utilize similar steps as discussed in Steps 500-512 to implement the functions in Steps 1046-1050.

Juror view mode menu 1052 may be selected by the user to rapidly toggle the view from the seating chart generated in either Steps 800-824 and/or Steps 1002-1004 to a detailed view of a single juror as shown in FIG. 21. The juror view mode menu may also enable the user to view information regarding a particular potential juror. Selection of the juror view mode menu may automatically toggle the seating chart/juror detail view mode in Step 1054.

Any changes or modification made by the user in the main case interface can be saved by selecting the close and save feature in Step 1056.

FIG. 10B illustrates additional features that may be included within the main case interface 1000. A juror score override option in Step 1058 may be provided to enable the user to override all rates automatically assigned by the jury selection management system 200 to the maximum score awarded to either the plaintiff/prosecution or defense. The override feature may be implemented, for example, to override the rating assigned all responses received from a particular potential juror and to override the rating assigned to a personal characteristic of a particular potential juror in Step 1060. The system may permit the user to override ratings assigned to several jurors in Step 1062. For example, if several jurors based upon their demeanor showed a preference to either party, the user could flag these jurors by assigning them the maximum score associated with the respective party.

In steps 1063-1066, the jury selection management system 200 may also allow a user to flag a juror's body language such as a roll of the eyes, or a nod to an attorney's remark. Any significant body language may result in a symbol being entered and displayed next to a particular juror's name or in the box assigned to a particular juror in the seating chart. The user may enter any body language that may occur, for example, during the selection process, during breaks provided during the selection process, or as the potential jurors enter the courtroom. The body language feature in Step 1063 may also be used to record the body language of the potential jurors, as well as the body language of any participant of the case such as the judge, any member of the opposing party, as well as any member of the audience.

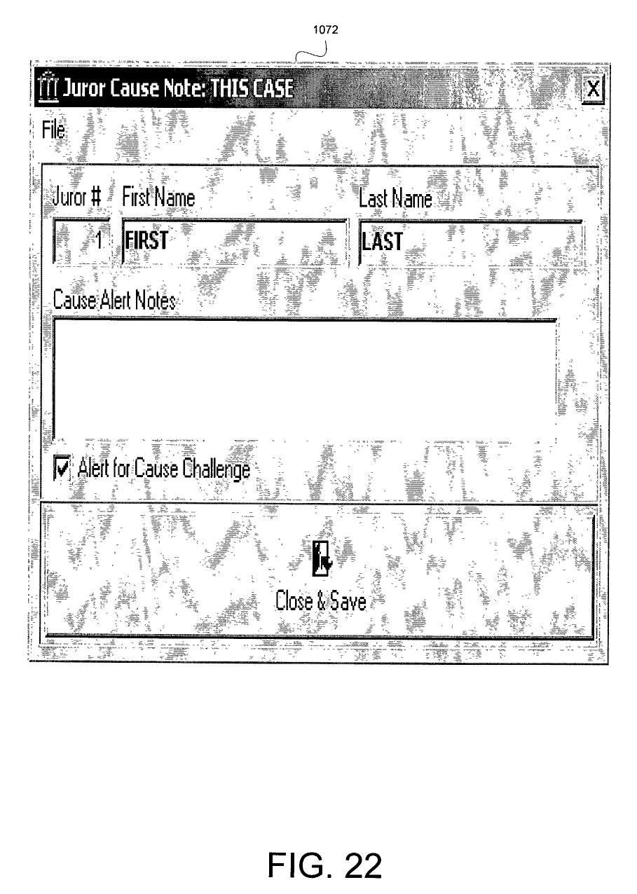

Another aspect of the invention may include a cause alert feature, which can be implemented in Steps 1068-1074. If a party believes that someone in the courtroom has made a statement that calls for a challenge for cause, the user can record the cause for challenge manually, as shown in FIG. 22. Alternatively, the user may activate a selectable feature or symbol listed on a pre-programmed menu of challenges to enter the challenge. A symbol such as a “C” shown in FIGS. 21 and 23B may be selected. FIG. 23B provides a view of the type of information that may be displayed on the seating chart regarding each potential juror. Once a challenge is entered and its description has been added into the system in Step 1072, as discussed above, the jury selection management system 200 may automatically initiate a search of a case law database to support the challenge. Step 1074 may enable the user to enter a cause for challenge for several different jurors or participant of the case or to enter multiple causes for challenge for a single potential juror or participant of the case.

Steps 1076-1082 may enable the user to add a rating or modify a rating assigned to a particular potential juror as shown in FIGS. 19B-19C. As shown in FIG. 16C, a note box may be provided as a feature of the invention that enables the user to quickly enter any notes or comments regarding a particular juror into the system in Steps 1084-1090. The potential juror status change button may allow the user to select and mark those potential jurors that have been designated to serve on the jury or act as an alternate juror, and to designate those jurors that have been dismissed by plaintiff/prosecution or defense peremptory or for cause. Furthermore, by selecting the buttons, such as the plaintiff button, the defendant button, the cause button and the alternate button, the user may cause the system to generate a quick reference list of the potential jurors whom have been designated to the respective categories. For example, by activating the cause button, the system may generate a list of all the potential jurors whom were stricken for cause. The plaintiff button may provide a list of the members of the jury who were selected by the plaintiff.

In addition, the jury selection management system 200 may allow the user at anytime during the jury selection process to automatically rate the potential jurors based upon the scores or ratings entered regarding each potential juror. As shown in FIG. 24, the system may provide both plaintiff ratings and defendant ratings. The plaintiff ratings may provide a list according to the jurors who are more favorable to the plaintiff. The plaintiff list may be arranged based upon several factors such as the potential juror having the highest score that is most favorable to the plaintiff, the potential juror having the lowest score, a particular demographic, and/or by the potential jurors name. Likewise, a defendant rating may be automatically generated as shown in FIG. 24.

In general, the jury selection management system 200 provides a party in a legal dispute with a method and apparatus for automatically ranking the potential jurors based upon how the jurors have responded to the questions. The jury selection management system 200 may also provide pre-programmed factoring based upon each potential juror's demographics and body language. The system may automatically combine all the recorded information and assign a ranking to the members of the jury panel. After the ranking has been generated, the system may provide a quick overview of each potential juror, his or her responses, body language and or demographics in order to assist a party in determining whether a potential juror's score is high enough or low enough to be selected as a member of the jury. Furthermore, the jury selection management system 200 may also aid the user to determine the likely foreman of the jury.

One having ordinary skill in the art will readily understand that the steps of the method may be performed in different order, or with multiple steps in parallel with one another. Also, one having ordinary skill in the art will understand that a network device may be configured to perform the above-described method either in silicon or in software. Accordingly, one will understand that the switching configurations described herein are merely exemplary. Accordingly, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A system for selecting members of a jury, said system comprising:
a memory device; and
a processor in communication with said memory device, said processor configured to record courtroom event information, in real time, based upon events occurring within a courtroom during a jury selection process and to select said members of said jury from a juror panel based upon said courtroom event information.

2. The system as recited in claim 1, wherein said processor is further configured to record responses provided from at least one potential juror during a voir dire process.

3. The system as recited in claim 2, wherein said processor is further configured to:
assign a rating to said responses; and
perform a statistical analysis on said responses based upon said rating to select said members of said jury.

4. The system as recited in claim 1, wherein said processor is further configured to:
receive potential juror information;
assign a rating to said potential juror information, and
perform a statistical analysis on said potential juror information based upon said rating to select members of a jury.

5. The system as recited in claim 4, wherein said potential juror information comprises background information related to at least one potential juror and wherein said background information is provided, in real time, during said selection process to said processor.

6. The system as recited in claim 1, wherein said processor is further configured to record, in real time, statements made during the jury selection process, wherein said statements support a legal challenge asserted by at least one participant of said jury selection process.

7. The system as recited in claim 6, wherein said processor is further configured to provide case law data to support said legal challenge.

8. The system as recited in claim 7, wherein said legal challenge comprises a challenge for cause.

9. The system as recited in claim 7, wherein said legal challenge comprises a challenge to a jury array.

10. The system as recited in claim 7, wherein said legal challenge comprises a general challenge.

11. The system as recited in claim 6, wherein said legal challenge comprises a peremptory challenge.

12. The system as recited in claim 6, wherein said processor is further configured to provide a total of at least one or more legal challenges asserted by said at least one party during said jury selection process.

13. The system as recited in claim 2, wherein said processor is further configured to receive an input indicating at least one body language action exhibited by a potential juror during said jury selection process and to record said at least one body language action exhibited by a potential juror during said jury selection process.

14. The system as recited in claim 13, wherein said processor is further configured to:
assign a rating to said body language action; and
perform a statistical analysis on said responses to select said members of said jury

15. A system for selecting members of a jury, said system comprising:
a memory device; and
a processor in communication with said memory device, said processor configured to receive pre-jury selection preparation information, record courtroom event information, in real time, based upon events occurring within a courtroom during a jury selection process, and select said members of said jury from a juror panel based upon said courtroom event information and said pre-jury selection preparation information.

16. The system as recited in claim 15, wherein said processor is further configured to dynamically update said pre-jury selection preparation information with said courtroom event information during said jury selection process.

17. The system as recited in claim 16, wherein said pre-jury preparation information comprises a question database generated for preparing questions presented to at least one potential juror during said jury selection process.

18. The system as recited in claim 16, wherein said pre-jury preparation information comprises a background database for conducting a background investigation of at least one potential juror.

19. A system for recording courtroom event information, said system comprising:
a memory device; and
a processor in communication with said memory device, said processor configured to record, in real time, statements made during a jury selection process, wherein said statements support at least one legal challenge asserted by at least one participant of said jury selection process; and utilize a jury selection management system to select members of a jury based upon said statements made during said jury selection process and said at least one legal challenge asserted during said jury selection process.

20. The system as recited in claim 19, wherein said processor is further configured to provide case law data to support said legal challenge.

21. The system as recited in claim 20, wherein said legal challenge comprises a challenge for cause.

22. The system as recited in claim 20, wherein said legal challenge comprises a challenge to a jury array.

23. The system as recited in claim 20, wherein said legal challenge comprises a general challenge.

24. The system as recited in claim 19, wherein said legal challenge comprises a peremptory challenge.

25. The system as recited in claim 19, wherein said processor is configured to provide a total of at least one or more legal challenges asserted by said at least one participant during said jury selection process.

26. A system for creating a seating chart of members of a juror panel, said system comprising:
a memory device; and
a processor in communication with said memory device, said processor configured to receive an input indicating seating positions assigned to potential jurors, to record said seating positions assigned to said potential jurors, in real time, during a jury selection process, to create a seating chart based upon said seating positions, in real time; and provide selectable representations, in real time, based upon said seating chart, wherein said selectable representations represent said potential jurors on a display screen of said processor.

27. The system as recited in claim 26, wherein said processor is further configured to:
receive potential juror information;
assign a rating to said potential juror information;
assign said potential juror information to said selectable representations on said display screen, and
perform a statistical analysis on said potential juror information to select members of a jury.

28. The system as recited in claim 26 wherein said processor is further configured to:
receive responses made by said potential jurors, in real time, during said jury selection process;
assign a rating to said responses; and
perform a statistical analysis on said responses made by said potential jurors, in real time, during said jury selection process.

29. The system as recited in claim 26, further comprising:
a photographic image device coupled to said processor and for capturing a photographic image of at least one potential juror;
wherein said processor is configured to receive from said photographic image
device data representing said photographic images of said potential jurors; and
wherein said data representing said photographic images is displayed as selectable representation within said seating chart on said display screen.

30. The system as recited in claim 26, wherein said processor is further configured to record, in real time, statements made during the jury selection process, wherein said statements support a legal challenge asserted by at least one participant during said jury selection process.

31. The system as recited in claim 30, wherein said processor is further configured to display within said seating chart on said display screen a symbol indicating said legal challenge.

32. The system as recited in claim 31, wherein said processor is further configured to provide case law data to support said legal challenge.

33. The system as recited in claim 32, wherein said processor is further configured to provide said case law data to support said legal challenge and wherein said legal challenge comprises a challenge for cause.

34. The system as recited in claim 32, wherein said processor is further configured to provide said case law data to support said legal challenge and wherein said legal challenge comprises a challenge to a jury array.

35. The system as recited in claim 32, wherein said processor is further configured to provide said case law data to support said legal challenge and wherein said legal challenge comprises a general challenge.

36. The system as recited in claim 32, wherein said processor is further configured to provide said case law data to support said legal challenge and wherein said legal challenge comprises a peremptory challenge.

37. The system as recited in claim 31, wherein said processor is further configured to provide a total of at least one or more legal challenges asserted by said at least one participant during said jury selection process.

38. A method of using a computer to select members of a jury, said method comprising:
recording, using a computer, courtroom event information, in real time, based upon events occurring within a courtroom during a jury selection process; and
processing said courtroom event information to select said members of said jury from a juror panel based upon said courtroom event information.

39. The method as recited in claim 38, wherein said processing of said courtroom event information further comprises recording responses provided from at least one potential juror during a voir dire process.

40. The method as recited in claim 39, wherein said processing further comprises:
assigning a rating to said responses; and
performing a statistical analysis using said responses and said rating to select said members of said jury.

41. The method as recited in claim 38, wherein said processing further comprises:
receiving potential juror information;
assigning a rating to said potential juror information, and
performing a statistical analysis using said potential juror information and said rating to select members of a jury.

42. The method as recited in claim 41, wherein said receiving further comprises: receiving background information related to at least one potential jurors, in real time, during said selection process to said processor.

43. The method as recited in claim 38, wherein said processing further comprises recording, in real time, statements made during the jury selection process, wherein said statements support a legal challenge asserted by at least one participant during said jury selection process.

44. The method as recited in claim 43, wherein said processing further comprises providing case law data to support said legal challenge.

45. The method as recited in claim 43, wherein said processing further comprises providing a total of at least one or more legal challenges asserted by said at least one participant during said jury selection process.

46. The method as recited in claim 39, wherein said processing further comprises:
receiving an input indicating at least one body language action exhibited by a potential juror during said jury selection process; and
recording said at least one body language action exhibited by a potential juror during said jury selection process.

47. The method as recited in claim 46, wherein said processing further comprises:
assigning a rating to said body language action; and
performing a statistical analysis on said responses to select said members of said jury based upon said rating.

48. A method of using a computer to select members of a jury, said method comprising:
receiving, using a computer, pre-jury selection preparation information;
recording, in real time using a computer, courtroom event information, based upon events occurring within a courtroom during a jury selection process; and
processing said pre-jury selection preparation information and said courtroom event information to select said members of said jury from a juror panel.

49. The method as recited in claim 48, wherein said processing further comprises dynamically updating said pre-jury selection preparation information with said courtroom event information during said jury selection process.

50. The method as recited in claim 49, wherein said receiving further comprises receiving information from a question database generated for preparing questions presented to at least one potential juror during said jury selection process.

51. The method as recited in claim 49 said receiving further comprises receiving information from a background database generated for conducting a background investigation of at least one potential juror.

52. A method of using a computer to record courtroom event information, said method comprising:
recording, in real time using a computer, statements made during a jury selection process, wherein said statements support at least one legal challenge asserted by at least one participant during said jury selection process; and
processing said statements utilizing a jury selection management system to select members of a jury based upon said statements made during said jury selection process and said at least one legal challenge.

53. The system as recited in claim 52, wherein said processing comprises providing case law to support said legal challenge.

54. The system as recited in claim 53, wherein said legal challenge comprises a challenge for cause.

55. The system as recited in claim 53, wherein said legal challenge comprises a challenge to a jury array.

56. The system as recited in claim 53, wherein said legal challenge comprises a general challenge.

57. The system as recited in claim 52, wherein said legal challenge comprises a peremptory challenge.

58. The system as recited in claim 52, wherein said processing comprises providing a total of at least one or more legal challenges asserted by said at least one participant during said jury selection process.

59. A method of using a computer to create a seating chart of members of a juror panel, comprising:
receiving an input indicating seating positions assigned to potential jurors during a jury selection process;
recording, in real time using a computer, said seating positions assigned to said potential jurors during a jury selection process;
processing said seating positions to create a seating chart based upon said seating positions, in real time; and
providing selectable representations, in real time, based upon said seating chart, wherein said selectable representations represents said potential jurors on a display screen of said processor.

60. The method as recited in claim 59 wherein said processing further comprises:
receiving potential juror information;
assigning a rating to said potential juror information;
assigning said potential juror information to said selectable representations on said display screen, and
performing a statistical analysis on said potential juror information to select members of a jury.

61. The method as recited in claim 59, wherein said processing further comprises:
receiving responses made by said potential jurors, in real time, during said jury selection process;
assigning a rating to said responses; and
performing a statistical analysis on said responses made by said potential jurors, in real time, during said jury selection process.

62. The method as recited in claim 59; wherein said processing comprises receiving photographic images of said potential jurors from a photographic image device, and
displaying said photographic images as selectable representation within said seating chart on said display screen.

63. The method as recited in claim 59, wherein said processing comprises recording, in real time, statements made during the jury selection process, wherein said statements support a legal challenge asserted by at least one participant of said jury selection process.

64. The method as recited in claim 63, wherein said processing comprises displaying within said seating chart on said display screen a symbol indicating said legal challenge.

65. The method as recited in claim 63, wherein said processing comprises providing case law to support said legal challenge.

66. The method as recited in claim 63, wherein said processing comprises providing a total of at least one or more legal challenges asserted by said at least one participant during said jury selection process.

67. A system for selecting members of a jury, said system comprising:
means for recording courtroom event information, in real time, based upon events occurring within a courtroom during a jury selection process; and
means for selecting said members of said jury from a juror panel based upon said courtroom event information.

68. A system for selecting members of a jury, said system comprising:
means for receiving pre-jury selection preparation information;
means for recording courtroom event information, in real time, based upon events occurring within a courtroom during a jury selection process; and
means for selecting said members of said jury from a juror panel based upon said courtroom event information and said pre-jury selection preparation information.

69. A system for recording courtroom event information, said system comprising:
means for recording, in real time, statements made during a jury selection process, wherein said statements support at least one legal challenge, asserted by at least one participant of said jury selection process; and
means for utilizing a jury selection management system to select members of a jury based upon said statements made during said jury selection process and said at least one legal challenge.

70. A system for creating a seating chart of members of a juror panel, said system comprising:
means for receiving an input indicating seating positions assigned to potential jurors;
means for recording, in real time, said seating positions assigned to said potential jurors during a jury selection process;
means for creating, in real time, a seating chart based upon said seating positions, in real time; and
means for providing, in real time, selectable representations based upon said seating chart, wherein said selectable representations represent said potential jurors on a display screen of said processor.

71. A system for selecting members of a jury, said system comprising:
means for recording, in real time, courtroom event information based upon events occurring within a courtroom during a jury selection process;
means for receiving an input indicating at least one body language action exhibited by a potential juror during said jury selection process;
means for recording, in real time, said at least one body language action exhibited by said potential juror during said jury selection process;
means for selecting said members of said jury from a juror panel based upon said courtroom event information and said body language action.

72. A system for selecting members of a jury, said system comprising:
a computer readable medium having computer readable program means embodied therein, said computer readable program means for:
recording courtroom event information, in real time, based upon events occurring within a courtroom during a jury selection process; and
selecting said members of said jury from a juror panel based upon said courtroom event information.

73. A system for selecting members of a jury, comprising:
a computer readable medium having computer readable program means embodied therein, said computer readable program means for:
receiving pre-jury selection preparation information;
recording courtroom event information, in real time, based upon events occurring within a courtroom during a jury selection process; and
selecting said members of said jury from a juror panel based upon said courtroom event information and said pre-jury selection preparation information.

74. A system for recording courtroom event information, comprising:
a computer readable medium having computer readable program means embodied therein, said computer readable program means for:
recording, in real time, statements made during a jury selection process, wherein said statements support at least one legal challenge asserted by at least one participant of said jury selection process; and
utilizing a jury selection management system to select members of a jury based upon said statements made during said jury selection process and said at least one legal challenge.

75. A system for creating a seating chart of members of a juror panel, comprising:
a computer readable medium having computer readable program means embodied therein, said computer readable program means for:
receiving an input indicating seating positions assigned to potential jurors;
recording, in real time, said seating positions assigned to said potential jurors during a jury selection process;
creating, in real time, a seating chart based upon said seating positions and
providing, in real time, selectable representations, in real time, based upon said seating chart, wherein said selectable representations represents said potential jurors on a display screen of said processor.

76. A system for selecting members of a jury, comprising:
a computer readable medium having computer readable program means embodied therein, said computer readable program means for:
recording, in real time, courtroom event information, in real time, based upon events occurring within a courtroom during a jury selection process;
receiving an input indicating at least one body language action exhibited by a potential juror during said jury selection process;
recording, in real time, said at least one body language action exhibited by said potential juror during said jury selection process;
selecting said members of said jury from a juror panel based upon said courtroom event information and said body language action.

77. A system for recording courtroom event information, comprising:
a memory device; and
a processor in communication with said memory device, said processor configured to:
receive an input indicating at least one body language action exhibited by a potential juror during said jury selection process;
record said at least one body language action exhibited by said potential juror during a jury selection process; and
utilize a jury selection management system to select members of a jury based upon the at least one body language action exhibited by said potential juror during said jury selection process.

78. A method of using a computer to record courtroom event information, said method comprising:
receiving an input indicating at least one body language action exhibited by a potential juror during said jury selection process
recording, using a computer, said at least one body language action exhibited by said potential juror during a jury selection process; and
utilizing a jury selection management system to select members of a jury based upon the at least one body language action exhibited by said potential juror during said jury selection process.

79. A system for selecting members of a jury, said system comprising:
a memory device; and
a processor in communication with said memory device, said processor configured to record courtroom event information based upon events occurring within a courtroom during a jury selection process and to select said members of said jury from a juror panel based upon said courtroom event information.

80. A system for selecting members of a jury, said system comprising:
a memory device; and
a processor in communication with said memory device, said processor configured to receive pre-jury selection preparation information, record courtroom event information based upon events occurring within a courtroom during a jury selection process, and select said members of said jury from a juror panel based upon said courtroom event information and said pre-jury selection preparation information.

81. A system for recording courtroom event information, said system comprising:
a memory device; and
a processor in communication with said memory device, said processor configured to record statements made during a jury selection process, wherein said statements support at least one legal challenge asserted by at least one participant of said jury selection process; and to utilize a jury selection management system to select members of a jury based upon said statements made during said jury selection process and said at least one legal challenge asserted during said jury selection process.

82. A system for creating a seating chart of members of a juror panel, said system comprising:
a memory device; and
a processor in communication with said memory device, said processor configured to receive an input indicating seating positions assigned to potential jurors, to record said seating positions assigned to said potential jurors during a jury selection process, to create a seating chart based upon said seating positions, and to provide selectable representations based upon said seating chart, wherein said selectable representations represent said potential jurors on a display screen of said processor.

83. A method of using a computer to select members of a jury, said method comprising:
recording, using a computer, courtroom event information based upon events
occurring within a courtroom during a jury selection process; and processing said courtroom event information to select said members of said jury from a juror panel based upon said courtroom event information.

84. A method of using a computer to select members of a jury, said method comprising:
receiving, using a computer, pre-jury selection preparation information;
recording, using a computer, courtroom event information, based upon events occurring within a courtroom during a jury selection process; and
processing said pre-jury selection preparation information and said courtroom event information to select said members of said jury from a juror panel.

85. A method of using a computer to record courtroom event information, said method comprising:
recording, using a computer, statements made during a jury selection process, wherein said statements support at least one legal challenge asserted by at least one participant during said jury selection process; and
processing said statements utilizing a jury selection management system to select members of a jury based upon said statements made during said jury selection process and said at least one legal challenge.

86. A method of using a computer to create a seating chart of members of a juror panel, comprising:
receiving an input indicating seating positions assigned to potential jurors during a jury selection process;
recording, using a computer, said seating positions assigned to said potential jurors during a jury selection process;
processing said seating positions to create a seating chart based upon said seating positions; and
providing selectable representations, based upon said seating chart, wherein said selectable representations represents said potential jurors on a display screen of said processor.
